(19) United States
(12) Patent Application Publication
(10) Pub. No.: US 2008/0033897 A1
(43) Pub. Date: Feb. 7, 2008

(54) Object Oriented System and Method of Graphically Displaying and Analyzing Complex Systems

(76) Inventor: Kenneth A. Lloyd, Albuquerque, NM (US)

Correspondence Address: BAKER & DANIELS LLP, 300 NORTH MERIDIAN STREET, SUITE 2700, INDIANAPOLIS, IN, 46204, US

(21) Appl. No.: 11/833,092

(22) Filed: Aug. 2, 2007

Related U.S. Application Data
(60) Provisional application No. 60/821,237, filed on Aug. 2, 2006.

(51) Int. Cl. G06N 7/00; G06F 17/10

(52) U.S. Cl. 706/19; 703/2

(57) ABSTRACT

The present invention involves with a system and method which assists a user in solving a complex problem, or determining the nature of a problem when it cannot be resolved. The computer has a processor and memory for storing instructions. The hybrid network software module in the memory enables a multi-dimensional mathematical model of a real world situation based on relevant parameters. The context software module in the memory provides the parameters to the hybrid network software and defines relationships within the hybrid network software. The context software module further has an interface for allowing the user to change the parameters and the relationships. The manipulation software module in the memory is adapted to change at least one of the hybrid network software module and the context software module based on one of changes to the internal definition of the mathematical model and changes in values external to the mathematical model.

### CROSS-REFERENCE TO RELATED APPLICATIONS

The present application claims priority under 35 U.S.C. § 119(e) of U.S. Patent Provisional Application Ser. No. 60/821,237, filed Aug. 2, 2006, the disclosure of which is explicitly incorporated by reference in this application.

### BACKGROUND OF THE INVENTION

1. Field of the Invention

The invention relates to modeling software. More specifically, the field of the invention is that of modeling software for graphical representations and solutions to complex systems.

2. Description of the Related Art

The approaches described in this section could be pursued, but are not necessarily approaches that have been previously conceived or pursued. Therefore, unless otherwise indicated herein, the approaches described in this section are not teachings or suggestions of the prior art to the claims in this application and are not admitted to be prior art by inclusion in this section.

In 1948, Warren Weaver authored an article “Science and Complexity” [Warren Weaver, Science and Complexity, American Scientist 36 (1948), no. 536.] stating that “up until the 1900's science was primarily concerned with two-variable problems of simplicity.” In that same year, Claude Shannon introduced us to a concept he termed entropy [Claude E. Shannon, A Mathematical Theory of Communication, The Bell System Technical Journal 27 (1948), 379-423, 623-656.]—a relationship between information and randomness in communication systems. Science and engineering have subsequently come to realize that the interconnected relationships in multivariate, large-scale systems are problematic because they are complex. In attempting to analyze and understand what complexity means within those systems, it was discovered that a higher number of dimensions—meaning degrees of freedom—in addition to non-linear dynamics and mutual coupling of system elements were correlated with erratic or chaotic behavior. Without providing a formal definition of complexity, which has historically proved difficult, the challenge has been to parameterize metrics regarding various characterizations of complexity, and to learn to utilize information contained in that data in developing successful future systems.

Traditional systems engineering attempts to iteratively break the complex task down into successively smaller pieces for analysis and synthesis as the means for dealing with complexity. For systems that trend toward static behavior, such as bridges, buildings, and even televisions and automobiles, this has been a good strategy. Systems engineering now realizes this traditional paradigm has proved inadequate for systems that change autonomically, or react to forces in environmental context, or both [Douglas Norman, Complexity in Engineering, INCOSE IW 2006, Mitre Corporation, February 2006.].

On a parallel path, the relatively new field of software engineering has likewise been troubled by the inadequacy of existing measures of software complexity. Early attempts to measure complexity in software—counting lines of code, function points or cycles (cyclometric complexity) have not substantially improved the success rate of large projects.

Applying the concepts of abstraction, encapsulation and polymorphism has proven to be helpful in de-coupling these complex systems to aid our understanding, but is still inadequate when unanticipated behavior emerges while the parts are assembled and interacting. Alone, these techniques do not address the forces that cause the nature of a system to change over time because they are based only on the static structure of the system and descriptive behavior.

Since the 1970's, the synergy between better education in mathematics and science, enabled by advances in personal computer technologies, has spawned new paradigms to help us better understand complexity.

Specifically, one of these new paradigms is the development of computer aided design (CAD). From the ability to precisely represent physical concepts on a computer, it was found that changes could be made in the design more easily, without starting over or inducing replication errors. Drawings could be put in blocks (encapsulation), and the blocks inserted into other drawings. These drawings were based on a mathematical graph structure that could be easily measured and changed. Attributes could be added to the blocks. It was realized that it was possible to extract information from those component attributes and use them to simulate behavior with mathematical functions, thus ameliorating the re-integration problem when the many parts were brought together. The ability to program the CAD application with these functions also meant we could allow a logical machine to create self-organizing designs. Applying this computationally optimized computer methodology to very large scale integration (VLSI) led to better integrated circuits and processors that perform many more calculations over much smaller periods of time.

Further, the hybrid network allows for calculations of maximum information from entropy/energy computations of small world networks between product development and development processes. These calculations provide the parametric input for the forward functions and their inverse refinements.

Learning how to program logical machines also had an emergent effect. It led to the examination of the theoretical relationships between the graphical representation of real world objects and the mathematical representation of graphs. Graphs may have given us the greatest insight into complexity. By graphing parameters of thermal convection, or biological propagation patterns, graphs may present a visualization of change that is beyond mathematical analysis. A relatively recent offspring of mathematics, graph theory has been elevated to new levels by such diverse domains as: Thermodynamics and Hydrodynamics; Biological sciences; Genomics; Earth sciences, such as meteorology and geology; and Computer science.

Graph theory emerged from the early concepts of rings, springs and vertex coloring. Through the integration of Boltzmann's probability with the thermodynamic concept of simulated annealing in algorithmic vertex placement, graph theorists have now developed sophisticated algorithms that can search and place many tens of thousands of vertices in a reasonable time. [Pavel Gajer and Stephen G. Korbourov, GRIP: Graph Drawing with Intelligent Placement, Journal of Graph Algorithms and Applications 3 (2002), no. 3, 203-224.] This reduction in computational complexity—the time it takes to resolve solutions to a problem, or at least to offer an approximation—has been instrumental in developing new ways of thinking about what constitutes “solutions” in complex problems. Some solutions are ephemeral or, more correctly, local. Some solutions bifurcate as they approach an invisible limit. Some solutions vacillate or become wildly chaotic [Steven Strogatz, Nonlinear Dynamics and Chaos, Perseus Publishing, Cambridge, Mass., 1994.].

Theory is fine for scientists, but engineers demand more practical tools. By application of the graphic analogy presented above to physical systems, the bond graph was developed. The concepts behind the bond graph started with the pioneering efforts of Christopher Bishop [Christopher Bishop, Neural Networks for Pattern Recognition, Oxford University Press, Oxford, UK, 1996.], and have been recently expanded by Pieter Mosterman [Pieter Mosterman, Hybrid dynamic systems: Hybrid bond graph modeling paradigm and its application in diagnosis, PhD Thesis, Vanderbilt University, 1997.] into popular simulation software. The bond graph allows the visualization of complex behavior from the simulation of “simple” systems, often yielding emergent behavior that may have been unanticipated a priori by an engineer. It could also be said that the bond graph has been the enabling tool in developing the science of “mechatronics”—modeling complex systems by physical analogy to electromechanical systems.

Another graph theoretic construct—the neural network—may be thought of as a network graph upon which information may be encoded. This is accomplished by algorithmically processing data and placing it parametrically on the graph by means of training sets. The training set represents a mathematical model that manipulates the network according to statistical principles similar to those based upon the work of Timothy Masters [Timothy Masters, Neural, Novel & Hybrid Algorithms for Time Series Prediction, John Wiley & Sons, New York, 1995.].

Mathematical and computer modeling are thus well known approaches to solving problems in complex systems. Simple physical systems may be modeled using equations with variables that are relatively easy to set up and solve. When more complex equations are introduced, and more variables are used, more approximations and errors in measurement and evaluation make solutions less predicable and reliable. Also, most models work best for common and “normal” (in a statistical sense) situations, but may break down near boundary conditions.

For example, Newtonian physics provides a good model for predicting the behavior of physical systems in common and normal circumstances. However, such models break down when objects approach the speed of light. Further, such models also break down when the number of objects and the forces acting on the objects multiply and interact. In such situations, the mathematical complexity may make the solution of such equations computationally infeasible. Approximations may be used to provide workable solutions, but such approximations introduce error, particularly at boundary conditions.

Another example involves the simulation of market forces. Supply and demand graphs may be used to accurately predict prices upon accurate measurement of supply or demand where such measurement may be precisely obtained, like in a three party market. However, the complex interactions of multiple players with multiple sources of supply, for example in a stock market, defy prediction using the same well tested supply and demand graphs.

While numerous modeling methods and software programs are known and are used in research, business, industry, and government, they generally fail to provide adequate assistance in those areas where complex and multi-faceted problems are encountered.

### SUMMARY OF THE INVENTION

The present invention is a system and method which allows users to model and work with complex systems in a comprehensible manner while still maintaining the rigor of the underlying model.

The invention, in one embodiment, consists of a software application library running on a personal computer workstation or a server computer. The software application takes data input from a file, an object parameter, or manual entry and creates what is termed a hybrid network structure (HN). This structure can be parameterized, manipulated algebraically, navigated, and ultimately visualized by the user as a graph. The input data may be encoded in a variety of forms including computer binaries, but usually it is in the form of an XML representation of a standard language model such as SOAP, XML, UML or SysML1 (UML and SysML are trademarks of the Object Management Group). In addition to the above functions that lead to visualization, this structure offers two important benefits. First, the graph structure may be used to simulate the behavior of the system. Second, the graph structure encodes information from the data.

One aspect of the present invention is realized by constructing a hybridization of digraphs, bond graphs, and neural networks and embedding it into a context. This provides a means for relating by edges the structures of the n-dimensional dynamical systems, which are represented as vertices. These network elements are embedded in a context-free embedding space, the graph, that taken together, represent the hybrid network graph. The parametric values associated with the vertices and edges are utilized by abstract analogy to represent energy, either as potential (present or stored) or flow (kinetic), in various forms, or constraints. These functions take place both within the network graph and upon the network graph from a surrounding context.

The context is also a hybrid network graph consisting of vertices, edges, and an embedding space that is referred to as a context space. The primary difference between the former is that the embedding space is a topological surface construct (therefore “hollow”) resembling some geometric shape, such as an environmental cube, polyhedra, or Riemannian sphere. This space may be used to model contexts such as an observers frame of reference, or an environmental interface in which potential/flow interactions take place. The context network elements are mapped onto the context space surface.

The method of the present invention involves determining certain metrics from data about the structure, behavior, and pattern of development of a current system under development from previously developed systems. When considering the development of new, large, and complex systems the method may be used to identify and quantify the nature of incompleteness, insufficiency, and complexity to be ameliorated. This is accomplished by iterative modeling of the system under observation using temporal and contextual dimensions. Modeling, within the context of the present invention, consists of the creation of a hybrid network graph structure, simulation, and refinement. The physics of that structure is extended from the well understood sciences of graph theory, statistical physics, dynamical systems, and thermodynamics. The network graph is created from information by a parser from standard formal models of the system under investigation which are represented in an n-dimensional graph structure. The metrics are then mapped onto an n-dimensional measuring (state) space referred to as a context space. The context space represents models that may be aligned with the data extant in the hybrid network by energy minimization techniques. Using forward and inverse functions, measures of action, reaction, and interaction derived from characteristics of the system and its context, may then be used to calculate, model, simulate, verify or validate phasic, non-linear and/or probabilistic system behavior. The objective is to aid the user in navigating and understanding the nature of the system.

Using the methods described above, we can now study dynamical systems, and that has given us a better weather forecasting, a better understanding of geophysics, a better understanding of biological behaviors, and a better understanding of the thermodynamic and hydrodynamic behavior of fluids. One of the remarkable outcomes from this study was a better understanding of the characteristics that take us from order and predictability, through vacillation and instability, and onto chaos.

These characteristics, in addition to three, seemingly unrelated but equally important discoveries, lead to the present invention:
1. At the same time that graph theory was maturing, geophysicists expanded on a generalization of Boltzman probability and distribution from statistical physics by integrating Bayesian methods. The insight into forward and inverse problem perspectives leads to inverse theory. Someone once said, it helps you measure how much you don't know. More correctly, it taught us about a system of forward and inverse thinking that allows us to make improved decisions about measurement and standards from models, data and uncertainty.
2. Research about the nature of flow, say of energy, through a system of interconnected circuits (a graph) has lead to the physical analogy of the bond graph and the discipline of mechatronics—using graphs that are analogous to electromechanical systems and simulating their behavior without physically constructing them.
3. Applying graph theory to a trivial game about who knows whom, an important discovery was made about navigation through incredibly large, seemingly random numbers of things. It is not the vast size that is remarkable. Rather, it is the unexpected, small-world characteristics exhibited within these incomprehensibly large, unpredictable systems that is surprising.

It is through synthesis of these myriad paths of scientific development that the present invention was spawned. Specifically, the present invention considers complex dynamic interactions from the flows and eddies of energy through a graphically represented neural network. As modulated by simulating flows through a context environment onto and through the network, the network learns from itself and past information. By applying this method to the processes of product development, we also can learn much about the product and the process. By iteratively encoding the knowledge learned into the network, the method of the present invention thereby improves both the nature of software development and the resulting software.

The present invention, in one form, relates to a computer for assisting a user in solving a complex problem. The computer includes a processor and memory for storing instructions. A hybrid network software module is in the memory and enables a multi-dimensional mathematical model of a real world situation based on relevant parameters. A context software module in the memory provides the parameters to the hybrid network software and defines relationships within the hybrid network software module. The context software module further has an interface for allowing the user to change the parameters and the relationships. A manipulation software module in the memory is adapted to change at least one of the hybrid network software module and the context software module based on one of changes to the internal definition of the mathematical model and changes in values external to the mathematical model.

The present invention, in another form, is a computer method for assisting a user in solving a complex problem. The method involves creating a multi-dimensional mathematical model of a real world situation based on relevant parameters using a hybrid network and a context module. The parameters are provided to the context module and relationships within the hybrid network software are defined. At least one of the hybrid network and the context module are manipulated based on one of changes to the internal definition of the mathematical model and changes in values external to the mathematical model.

Another aspect of the invention relates to a machine-readable program storage device for storing encoded instructions for a method of assisting a user in solving a complex problem according to the foregoing method.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic diagrammatic view of an embodiment of a computer hardware system using the present invention.

FIG. 2 is a schematic diagrammatic view of an embodiment of a PC workstation adapted to work within the present invention.

FIG. 3 is a schematic diagrammatic view of distributed software application components of an embodiment of the present invention.

FIG. 4 is a flow chart diagram view of reading data into one embodiment of the present invention.

FIG. 5 a flow chart diagram view of file manipulation of one embodiment of the present invention.

FIG. 6 is a flow chart diagram view of a parsing method according to one embodiment of the present invention.

FIG. 7 is a flow chart diagram view relating to determining vertex location according to one embodiment of the present invention.

FIG. 8 is a schematic diagram view of an encoding scheme according to one embodiment of the present invention.

FIG. 9 is a flow chart diagram view of a graphic display procedure according to one embodiment of the present invention.

FIG. 10 is a schematic diagram view of a context free Neural Network Graph.

FIG. 11 is a schematic diagram view of a hybrid network graph in context according to one embodiment of the present invention.

FIG. 12 is a schematic diagram view of FIG. 11 context free.

FIGS. 13A-C are bond graph diagram views according to embodiments of the present invention.

FIG. 14 is circuit diagram view illustrating a property of the present invention.

FIG. 15 is three dimensional chart diagram view representing marginal cost/revenue in context according to one embodiment of the present invention.

FIG. 16 is a schematic diagram view of parser selection according to one embodiment of the present invention.

FIG. 17 is a flow chart view of a UML parser method according to one embodiment of the present invention.

FIG. 18 is a flow chart view of a process data method according to one embodiment of the present invention.

FIG. 19 is a flow chart view of a forward and inverse processes according to one embodiment of the present invention.

FIG. 20 is a flow chart view of a graph placement method according to one embodiment of the present invention.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DESCRIPTION OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions which follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory, rather they represent specific electronic structural elements which impart a physical organization on the information stored in memory. More than mere abstraction, the data structures are specific electrical or magnetic structural elements in memory which simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein which form part of the present invention; the operations are machine operations. Useful machines for performing the operations of the present invention include general purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes, or it may comprise a general purpose computer as selectively activated or reconfigured by a computer program stored in the computer. The algorithms presented herein are not inherently related to any particular computer or other apparatus. In particular, various general purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code, each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects. Objects may also be invoked recursively, allowing for multiple applications of an object's methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment,” “running in windows,” and “object oriented operating system” are used to denote a computer user interface in which information is manipulated and displayed on a video display such as within bounded regions on a raster scanned video display. The terms “network,” “local area network,” “LAN,” “wide area network,” or “WAN” mean two or more computers which are connected in such a manner that messages may be transmitted between the computers. In such computer networks, typically one or more computers operate as a “server,” a computer with large storage devices such as hard disk drives and communication hardware to operate peripheral devices such as printers or modems. Other computers, termed “workstations,” provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The terms “desktop,” “personal desktop facility,” and “PDF” mean a specific user interface which presents a menu or display of objects with associated settings for the user associated with the desktop, personal desktop facility, or PDF. When the PDF accesses a network resource, which typically requires an application program to execute on the remote server, the PDF calls an Application Program Interface, or “API,” to allow the user to provide commands to the network resource and observe any output. The term “Browser” refers to a program which is not necessarily apparent to the user, but which is responsible for transmitting messages between the PDF and the network server and for displaying and interacting with the network user. Browsers are designed to utilize a communications protocol for transmission of text and graphic information over a world wide network of computers, namely the “World Wide Web” or simply the “Web,” Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats in conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA,” as defined above, means any handheld, mobile device that combines computing, telephone, fax, e-mail, and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”). The terms “wireless application protocol” or “WAP” mean a universal specification to facilitate the delivery and presentation of web-based data on handheld and mobile devices with small user interfaces.

The term “context” relating to the present invention involves a space that is an N-dimensional, measurable embedding space within which the hybrid graph is embedded. The dimensions of the space extend to represent various meanings, and in fact include real, imaginary, and/or non-integer numbers. Thus context may also be considered an environment that causes the graph path to curve. For example, if our perspective were from above, looking down on the graph, is there some unseen topological feature that, in addition to a force analogous with gravity, attracts the path? Assuming I graphed my experiences over several times (and I didn't get any stronger), the variations in the graph trajectory represents either forces of attraction or forces of repulsion (if the trajectory were to bifurcate). If I got stronger, the entire graph would shift over time. All of these “features” are of interest to systems analysis. [Specifically, features are what one looks for.] Unlike being lost in a featureless fog of a randomly dispersed homogeneous space, features become “hints” at the small world properties used to ameliorate some aspects of complexity. By ordering elements according to feature metrics using a context space, navigation of the network graph is easier, and navigation is a great help in working with complex systems. (Trivial example: alphabetizing surname names in a phonebook facilitates finding the phone number associated with that name. However there is no significance between the starting letter of your last name and your phone number). One useful feature of embedding a network in a graph is various perspectives from observation locations. “Inside” the context (on the network path, looking out to one of the dimensions of meaning) one can “see” that given a mass of 25 kG, I could carry it about 45 meters. Outside the context (looking in as one does reading the graph mapped on the sheet of paper), one can “see” that there is a non-linear relationship between the distance and the mass that seems to be fairly deterministic. Other observers, located in different locations outside the context may “see” a different picture of the system, as if one were looking on the sheet from a severe angle.

The invention involves a distributed software application running on personal computer work-station or a server connected to a network of servers and workstations, the network being either a LAN, WAN or combination of both. The term server may refer a single high performance computer such as a supercomputer. The term servers may refer to a cluster of networked computers such as a Beowulf cluster. The software provides novel interfaces and methods for a user to create, manipulate, simulate and visualize the structure, coupling and behavior of: 1. A Hybrid Network Graph (HN—also referred to as the System Graph); 2. A Context in which the Hybrid Network Graph is embedded; 3. Methods to relate energy, information and entropy; 4. Methods for simulation of the System Graph within a Context; 5. Methods to computationally refine Data and Models by Forward and Inverse Bayesian techniques; and 6. Methods to permit viewing of the graphical representations of the above.

The integration of the computer system, the object constructs of the Hybrid Network Graph and the Context, and the Methods implemented by the software to relate, simulate, refine and view data and models is referred to as Network Hybrid Modeling System. The component parts of the system are described as follows:

The Hybrid Network Graph & Engine. One aspect of the invention is a method for creating the hybrid network (HN) model graph that represents a system under examination. For convenience, this is also referred to as a system graph (in reference to a context-free system). We refer to the methods used in creating the HN as the hybrid network engine. The networks are created by extending Petri-net-like graphs using this engine, creating hybrids of digraphs, bond graphs and neural networks that exist as objects in a computer memory. The coupling, structure and behavior of these networks may be parameterized and constructed based upon the placement of vertices according to the connection of the edges. This graph is ultimately extended to represent a computational model of systems for simulation.

The engine has the capability of creating many such graphs representing many potential models having differing energy configurations. Furthermore, these vertex and edge objects are extended into parameterized neural network objects whose abstractions can be represented by graphs drawn on a monitor, or printed on a sheet of paper. Changes in the network graph over time are attributed to a change in energy, information content, and learning (at least in some sense of the word). Learning takes place from the frequent effects of the flow of forms of energy upon, into, though and out of the graph. This flow known as perturbations or activations, which are indicative of the dynamic behavior of the system. This means that the network “learns” from physical manifestations of dynamic behavior.

The method of the present invention involves applying this physical analogy to models of information about systems. These information models may be represented by a native language such as a serialized binary, a standard computer language such as Java or C#, a standard data transfer language such as XML, XMI (XMI—XML Metadata Interchange, is the standard XML based file format for exchanging UML and SysML models and interpreted by an XML Schema Definition (XSD) schema), SOAP, or written in some formal language such as the Unified Modeling Language (UML), the Systems Modeling Language (SysML), DIMACS format, GraphML, AP-233 or other natural language consistent with the input or DOM parser translation capabilities of the invention. These are converted into a standard typed format for processing by the parser function into data and metadata (“METADATA” is a trademark of the Metadata Company; here, the term “metadata” is used to mean “data about data”) components. From the common graph data structures, many types of graphs may be created, depending upon the amount and classification of data provided. Additionally, any one graph may have several uses.

For example, in an UML static structure diagram, nodes represent classes that are connected by edge relationships, such as Generalization, Association, Aggregation and Composition. Navigable relationships represent the calls to the properties and methods associated with those classes, resulting in a call graph. Generalization represents a directional evolutionary path from primitive to complete classes.

Other graph constructs consist of, but are not limited to object creation, class development paths, requirements fulfillment networks, reference relationships, code pattern application, and development pattern application.

The physical analogy works as follows: a graph of the system under observation is created in the system memory. The layout of the graph is calculated by the computer using an extension of well understood force directed energy minimization (entropy maximization) calculations such as those of Fruchterman and Reingold (FR) [Thomas M. J. Fruchterman and Edward M. Reingold, Graph Drawing by Force-directed Placement, Software—Practice and Experience 21 (1991), no. 11, 1129 {1164.], Eades [G. di Battista, P. Eades, R. Tammassia, and I. Tollis, Graph Drawing: algorithms for the visualization of graphs, Prentice Hall, New York, 1984.], Harel and Hadany, Kamada and Kawai (KK).

The force directed method, one of the methods possibly used in the present invention, involve expansions upon algorithms such as those detailed by Gajer and Korbourov, utilizing a combination of FR and KK methods as detailed in their Graph dRawing with Intelligent Placement (GRIP). This method was selected for the ability to place large number of nodes in computationally short O(log n) time. The metrics obtained are based upon well known Boltzmann probabilities which relates the energy of the graph vertices:

$$ρ i = - \frac{1}{n} {ⅇ}^{- {E}_{i} / kT}$$

In other words the change in position of one vertex in relation to other vertices in the neighborhood according to the energy relationship:

$$\frac{{υ}_{i}}{V} = \frac{{ⅇ}^{- \frac{E ( {υ}_{i} )}{kT}}}{{\sum }_{i} {ⅇ}^{- \frac{E ( {υ}_{ i} )}{kT}}}$$

where the term e^{-E}^{ᵢ}^{/kT} represents the Boltzmann probability, where k is the Boltzmann constant 1.38065×10 [symbol] 23 joules/K, e′2:718281828, T is the temperature of the vertex state in K, Ei is the energy associated with vertex vi, and vi V is the change in location (vector) of the vertex.

Using simulated annealing calculations, the adjustments to the placement are made according to an algorithmic scheduling function of Kamada-Kawai and Fruchterman-Reingold methods.

Until the Hybrid Network model graph is embedded (also referred to as entangled) in the following context and extended temporally, the model structure and coupling between model elements are abstract, also referred to as context-free.

The Context. The context is an object in the computer memory that encapsulates four (4) object constructs which provide physical and informational parameters affecting interaction with the hybrid network model graph. The four constructs are: (1) The Contextual Space; (2) The Environmental Space; (3) The Context Graph; and (4) The Interface Nodes (on the Context Graph).

These four constructs encapsulate resources that may be characterized as having the capability and capacity to generate, consume, accept, reflect, store, transform, and transfer energy in some combination. For example, capability and capacity are modeled on orthogonal meaning spaces. Capacity limits capability and can be considered analogous to impedance (resistance and reactance) in a mechatronic system. Therefore, capacity and capability become functional elements in the context.

The HN system graph, when coupled with its context in time, represents a mechatronic dynamical system. The physical analogy as that an input from the context to the HN system graph represents energy. Energy flows of various efficiencies originate from the input (source) interfaces on the context and enter the HN system graph resulting in work (motion or pressure) or heat. The flow continues to the output (sink) interface node. At this point there are three specification of graph models of the system are available: (1) the HN system graph reorganizes itself over time resulting from energetic forces and simulated annealing (thermal interaction with the HN system graph and its context), (2) bond graphs that represent actual behavior to the HN, and 3) a combination of (1) and (2).

As the context may be adiabatic, the heat of the context raises with the thermal properties of the graph of the system under observation. The context may also be used to model external forces into the system under observation. These may be simple force and temperature environments, represented by changing the contour topology of context environment, or by using Ising or Potts models, or by using Transfer Theory constructs. The pulse and paths traveled are measured over several iterations creating frequency spectrums. The higher the frequency implies a higher level of energy as will be explained in detail later. The context consisting of the above components is used iteratively by the application in the following (generalized) ways: (1) To link the data stored within the system in a free—form way that allows the context space to structure data into possible knowledge patterns, wherein the resulting paths becomes the foundation for the navigation; (2) To link ontologies external to the system with the internal information. to facilitate communication between heterogeneous disciplines; (3) To simulate, compare, analyze and identify recurrent paths as patterns; and (4) To measure the actual behavior path length compared to the coupling distance.

The Contextual Space The first context construct, the Contextual Space, provides a meaningful frame of reference that commences by establishing an orientation in spacetime and provides the framework for encoding meanings and interfaces to the system.

The contextual space is analogous to n-dimensional Hilbert space, built up from the following primitives starting as an M4 Minkowski or pseudo-Riemannian space. The first vector to be determined is a gravitationally induced direction of down. If its magnitude is non-zero, it also establishes an opposite directional vector of up. If the down direction magnitude is zero, an artificial directional vector of up is specified. This axis is identified as the Y axis upon which a zero-point is defined as an offset to the gravitational barycenter. Additionally, this offset will be zero when co-located at the barycenter of the gravitational field. The primary purpose of the up vector is to establish a viewpoint frame of reference such as the up directional orientation of a camera.

A temporal space consisting of a wavefunction and a timeline extends the context from its zero-point forward in time, with said zero point referred to as now. The resulting construct intersection between the temporal space and the context converge upon the now point. These are propagated into the future tangentially oriented with the timeline spinor. This space represents that which was experientially or observationally possible in the past and what may be possible in the future. The tangent to the timeline represents a dimension orthogonal to our Y axis, and is referred to as the Z axis (whereupon the negative direction on the Z axis represents spacetime depth-past).

Orthogonal to both the Z and Y axes is the spacetime width dimension, referred to as the X axis. Co-located with each of the identified dimensional axes are spinor rotational axes i; j; k, such that i2+j2+k2=−1. Together, these represent a Lie group of permutations and associated probabilities for representing possible “things” in our world. When the physics are indeed realized on those dimensions, a field is generated in the space of that realization. Thus, for example, the behavior resulting from the coupling of space, gravity and time on the depositing of grains of sand, along with certain statements and measurements about spacetime restructuring of the resultant pile may be described.

Note that these dimensions, alone, do not describe any actual behavior, for they only describe a coupled relationship between degrees of freedom. The actual behavior formed by the coupling(s) may be described mathematically according to the physics realized on those dimensions.

Suppose we have a thermodynamically large system that is in constant thermal contact with the environment, which has temperature T, with both the volume of the system and the number of constituent particles fixed. This kind of system is called a canonical ensemble. Let us label the exact states (microstates) that the system can occupy by j (j=1, 2, 3, . . . ), and denote the total energy of the system when it is in microstate j as Eⱼ. Generally, these microstates can be regarded as discrete quantum states of the system.

To summarize, while the notions above are conceptually complex, are easily represented in a computer memory as a multi-dimensional array and the values of the system's real-time clock. Consistent with the pattern of separation of concerns noted above; the rows and columns of the array represent only the fact that the values contained are orthogonally coupled. The functor describes the function of an actual coupled behavior residing in yet another dimension (again, represented in computer memory as a multi-dimensioned array) and are coupled by reference. The identifiable headings for the columns and rows are stored as referenced metadata. Finally, the direction of projection of that dimension, relative to other coupled dimension is represented by a spinor object.

From understanding the contextual space field effects, the wavefunction is developed. The wave-function ψ generates superposed probability densities for all possible field outcomes (see below for more information).

For convenience in reducing the visual (subjective) complexity of multidimensional context spaces, an artificial homogeneous dimension, W is added to our construct. The reciprocal of this projective dimension (referred to as the Reciprocal Homogeneous W [RHW]) allows spatial reduction in a way that makes sense to humans. This represents a perspective view of context objects in restricted dimensions (2 or 3) as viewed on computer screen.

As we have noted, the mathematical construction of multidimensional context spaces are quite easy. Merely append a dimension representing a degree of freedom. This is accomplished by simply adding an element, row and/or column representing that degree of freedom to vectors or matrices. Additionally, a set of related matrices may be used to define the coupling behaviors. What is less well understood is the spinorial progression of orientations that relate the group's orthogonality of the degrees of freedom to each other. This quasi-rotational pattern is referred to as spinor wrapping. The present invention thus involves a method of representing high-dimensional objects more closely aligned with the mechanics in high-dimensional space. The resulting visual representation of this progression blends, rotates, changes handedness and dissolves multi-dimensional objects within its Lie group in spacetime. This technique is consistent with relativity in spacetime and allows the rate of assimilation of information by the user to be user controlled.

The Environmental Space. An extension of or into the contextual space, the Environmental Space construct adds such environmental dimensions as temperature and pressure to the volumetric constructs encoded in the Contextual Space. Note that gravity and time is used to orient the environment space in the context, and the positional center of gravity may be extended to concepts of mass in the Environmental Space and its gravity, therefore weight.

Of primary importance, the temperature content of the environment affects the thermodynamic placement of graph nodes. The thermal content of the environment may either be adiabatic or dispersive, depending upon the size of the environment to the system. If the heat quantity flows from the system graph (HN) to the environment, the thermodynamic activity of the system graph is cooled. The converse also holds.

The environmental space field is calculated to represent such features as convection, current eddies, isobars and differential pressures, electric and magnetic fields, relative humidity, ambient vibration, and other environmental conditions that affect the system under examination by providing energy. This includes motive forces and stress.

The Context Graph. The Context Graph construct is an network graph extension of the Hybrid Network Graph. As such, it may be manipulated by any of the methods used in manipulating and simulating HN graphs.

The purpose of the context graph is to encode information and entropy, and derive meaning from the context space. The context graph is projectively mapped onto the surface of the context space. This is accomplished by centering the barycenter of the context graph at zero-point of the context space. The context graph is then rotationally oriented according to context space primitives by quaternion. The nodes of the context graph are then projected by creating a vector equal to the radius of the context sphere (assuming a Riemannian context space and representing the complex radius r) at the derived ζ and Φ angles of the original vector from the barycenter to the node. Meanings are encoded in the context space as n-partite regions defined by the clustering of the context graph mapped to the context surface as the context dimensions are spinor unwrapped. Derived from the vertex degree k, the clustering coefficient measures the tendency of vertices to cluster in interconnected modules or groups within regions of the embedding space. The clustering coefficient Cᵢ of a vertex Vᵢ is defined as: The total number of edges between these neighbors is at most kᵢ(kᵢ−1)=2. If the actual number of edges between these kᵢ neighbors is nᵢ, then the clustering coefficient Cᵢ of the vertex Vᵢ is the ratio:

$${C}_{i} = \frac{2 {n}_{i}}{{k}_{i} ( {k}_{i} - 1 )}$$

The clustering of the vertices is measured by counting the number of unique triangular cycles of connected adjacent vertices. This is accomplished by the following simple graph coloring method:

$${C}_{i} = {\sum }_{j = 1}^{N} {V}_{j} \vert {V}_{j} ∈ {V}_{i} \& {V}_{j + 1} ∈ {V}_{i} , {V}_{j}$$

The clustering coefficient of the graph, which is a measure of the network's potential modularity, is averaged over all vertices clustering coefficients:

$$< C >= \frac{1}{N} {\sum }_{i = 1}^{N} {C}_{i}$$

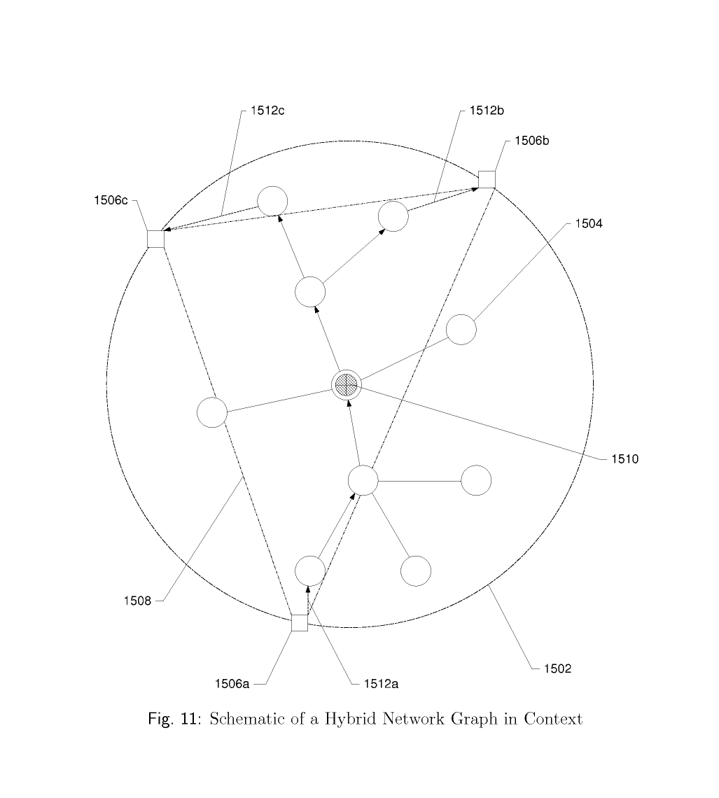

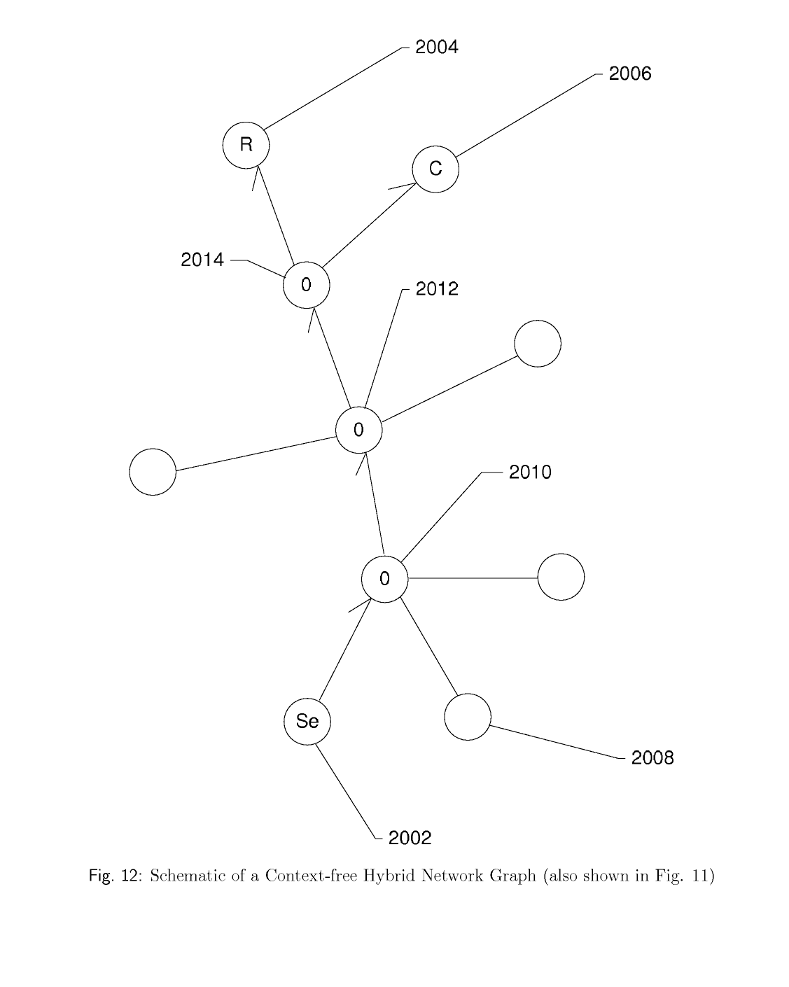

This is illustrated in FIG. 11 for a simple example.

The final characteristic of interest regarding context graphs is the possibility of the existence of small world network shortcuts. These short paths are indicated by a crossover characteristic from large graphs related to the cluster size Cᵢ The number of these shortcuts is represented by:
<Nₛ>=φL

where Φ is the shortcut probability density and L is a regular graph lattice size.

$$ϕ = \frac{{( 1 - {p}_{c} )}^{k}}{2 {kp}_{c}}$$

The Interface Nodes. Certain nodes embedded in the Context Graph that also provide information and energy between the Hybrid Network model graph and the Context Space are extended to one of three kinds of interface nodes. These are: (1) Input Nodes; (2) Output Nodes; and (3) Bias Nodes.

These nodes have corresponding nodes on the Hybrid Network model graph (HN—or system graph). The edges that form connection bonds between the context and the system graph adjust their lengths, thereby orienting the system graph to minimize energy. This is accomplished by quaternion rotation of the system graph within the context. These nodes provide points of entry for perturbation energies, as well as representing neural network function nodes input, output and bias. The bias node represents behavior of an activation function. It should be noted that the hidden nodes of an artificial neural network derived from our HN model graph are the all the nodes of the HN model graph not involved in input and output.

Energy, Entropy and Information. Information in the context of the present invention is considered a value upon a realization in a dimension. This is consistent with both classical and quantum physics theories. While there is some controversy among scientists regarding whether or not information is physically embodied within a system, the method of informational embodiment within the invention is handled as a projection on the context. As the context consists of a temporal component, even informational events of extremely short persistence (scintilla) can be encoded in the temporal history. By utilizing projection, no actual thermodynamic overhead is incurred, thus rendering the controversy moot.

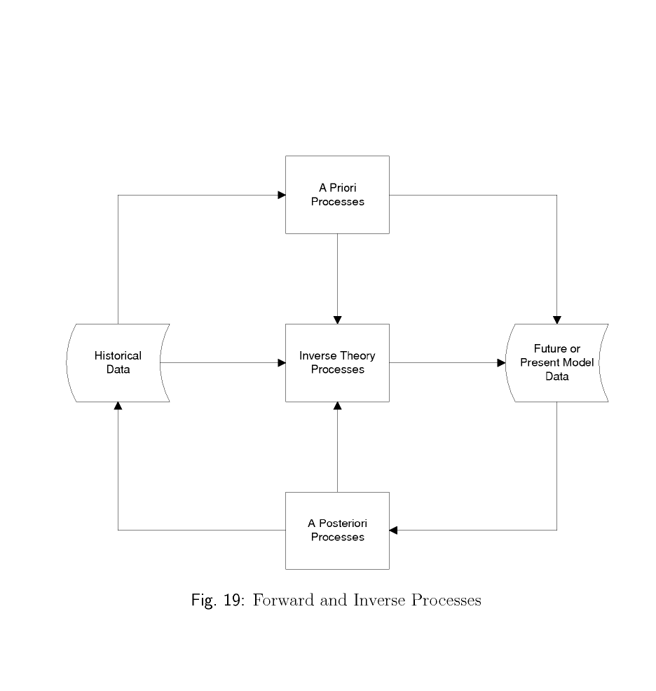

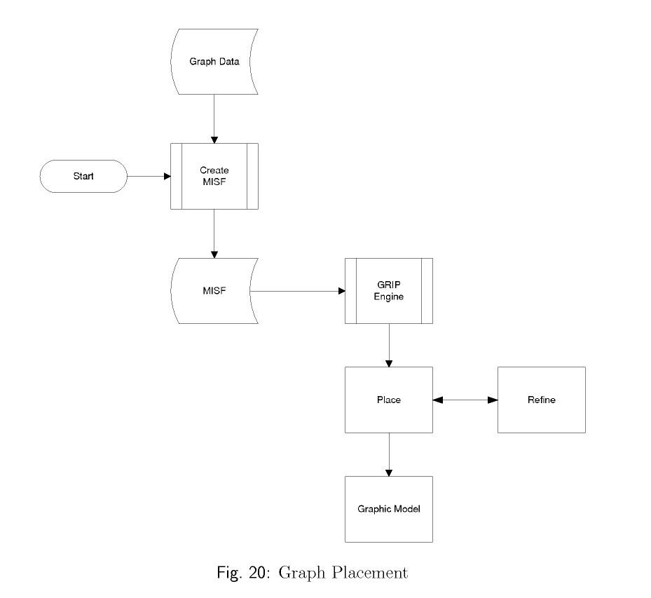

Forward and Inverse Functions. The present invention may utilize a cycle of measurements and refinements based upon information known through observation or measurement and that which is believed to be true but unknown (The definition of a priori information is information independent of observations, which therefore describes a model.) represented by conditional probabilities that couple the data and models (Ref. FIG. 19). These are fundamentally extensions upon Bayesian techniques. These techniques are well understood for linear functions in simple models. However, there are two characteristics of objective complexity in systems that are problematic. The first is the existence of three or more coupled dimensions. The second is that associated with those couplings is non-linear behavior. This is further complicated by three characteristics of subjective complexity; incompleteness, uncertainty and emergence. The cycle of measurement and refinement is accomplished by forward and inverse functions, as described by Mosegaard:
Early examples of analysis of non-linearizable inverse problems were mainly focused on the construction of best fitting models, but today it is widely acknowledged that uncertainty and non-uniqueness analysis is very important for the assessment of scientific conclusions based on inverse calculations.

The ramification of the above statement means that we may develop many models that accurately describe the data. Some of these models will prove to be incorrect, even though they seem to align with the data. Some will be implausible. And some, perhaps many, will represent “good” models. The challenge in measurement and refinement is the classification of these models. Using the methodologies of the present invention, such development and refinement of models is greatly facilitated.

Forward analysis. First, it is important to examine the relationship between the data and models, or in other words between the known and the probable. Model in this context means an a priori belief in what we know about a system under observation. The relationship is:
d=m+ε
where d is the data value from observation or measurement, m represents the model, and ε represents random measurement error under the assumption that all data is truly a function of the model:
d=ƒ(m)
meaning that there are no modeling or theoretical errors in m. This will subsequently be tested in the inverse analysis. Thus, the joint probability is stated
ƒ(d;m)=ƒ(djm)ƒ(m)

We apply this concept to a collection of data values stored in an array d=(d1; d2; d3:::dn)

$$d = {\sum }_{i = 1}^{n} {d}_{i}$$

as zero centered on the mean μ, with a deviation of σ (the variation as σ²) and a normal or Gaussian variance of β².
Thus, the forward problem is described as follows by Bayes Theorem:

$$f ( m \vert d ) = \frac{f ( d \vert m ) f ( m )}{f ( d )}$$

### The Forward Function (Bayes Theorem)

$$f ( d , m ) = exp [ - \frac{1}{2 {σ}^{2}} {\sum }_{i = 1}^{n} {( {d}_{i} - m )}^{2} ] exp [ - \frac{1}{2 {β}^{2}} {( m - μ )}^{2} ]$$

$$f ( d ) = \frac{n \overline{d} / {σ}^{2} + μ / {β}^{2}}{n / {σ}^{2} + 1 / {β}^{2}}$$

We formulate the models of the function ƒ(m) based upon a Metropolis—Monte Carlo (MMC) algorithm. Here, we realize the similar relationship between the MMC methods and the simulated annealing techniques applied in the placement of graph nodes. We also now realize that the answer is a probability distributions upon a collection of nearest neighbors (models).

$$f ( m ) = {\sum }_{i = 1}^{nn} f ( m )$$

To summarize these concepts, the forward probability that a system exists in one specific thermo-dynamic microstate is described by a Boltzmann distribution.

Inverse analysis. Inverse analysis starts with the problem statement that is recognized as the inverse of the Bayesian forward problem statement: From a set of models representing given sets of data, which model has the highest probability of correctly representing a set of data.

$$f ( d \vert m ) = \frac{f ( m \vert d ) f ( m )}{f ( d )}$$

However, instead of one model based upon a priori information, we are presented with many models:
ƒ(d|m)

The statistical distribution of which is:
σₘ(m)=ρₘ(m)L(m)
where σₘ(m) is the probability density over the model space. L(m) is represents a likelihood function that the data fits the model. Therefore an early test of HN model graphs is a comparison of the system under examination by using Monte Carlo methods to a random graph. In other words, we are comparing how well the HN model fits data as compared to distributions in a random model.

The Bayesian formulation of the Inverse Problem as shown by Mosegaard is:

$${σ}_{d} = C \frac{{ρ}_{d} {θ}_{d}}{{μ}_{d}}$$

$$L ( m ) = {ρ}_{d} ( f ( m ) )$$

A novel classification of this continuous measuring space is represented by the hierarchical histogram as follows:

Replication 1:00=value

Algorithmic 1:00>value, 0:75

Heuristic 0:75>value, 0:50

Judgmental 0:50>value, 0:25

Random Walk 0:25>value

Let P represent a tautological superposition, or in other words all the possible thermodynamic microstates of a system.

$$P ( m ) = {\sum }_{i = 1}^{n} ρ ( {m}_{i} ) = 1$$

$$ρ ∈ P$$

A Metropolis—Monte Carlo Computation Method. We use the Metropolis—Monte Carlo method to determine the thermal average of a quantity A associated with each microstate of a system in equilibrium at some temperature T:

$$< A >= \frac{1}{N} \int A ( x ) {ⅇ}^{- \frac{E ( x )}{kT}} ⅆ x$$

E(x) represents the energy state at a point x in the HN graph n-dimensional model space (A in joules, recall that a joule is one Watt-second or one Newton-meter). Therefore:

$$< A >= \frac{1}{N} {\sum }_{i = 1}^{N} A ( {x}_{i} ) {ⅇ}^{- \frac{E ( {x}_{i} )}{kT}}$$

and the partition function Z is described by:

$$Z = {\sum }_{i = 1}^{N} A ( {x}_{i} ) {ⅇ}^{- \frac{E ( {x}_{i} )}{T}}$$

The complete Monte Carlo method is therefore described by:

$$< A {>}_{est} = \frac{{\sum }_{i = 1}^{N} \frac{A ( {x}_{i} ) {ⅇ}^{- \frac{E ( {x}_{i} )}{kT}}}{{P}_{samp} ( {x}_{i} )}}{{\sum }_{i = 1}^{n} \frac{{ⅇ}^{- \frac{E ( {x}_{i} )}{kT}}}{{P}_{samp} ( {x}_{i} )}}$$

After canceling out the Boltzmann factors, the simplified relationship is:

$$< A {>}_{est} = \frac{{\sum }_{i = 1}^{N} A ( {x}_{i} )}{N}$$

The above procedure yields a context free graph that may be explored for its clustering and small world network properties that will be used for navigational purposes. The navigational meta-graph is constructed in between clusters identified by high degree vertices near the barycenter of the cluster, and the shortest path between these highest degree cluster nodes. A similar calculation is between a randomly selected leaf node in each cluster for construction of a special “short circuit” edge, thereby creating a small world network.

The “hybrid network” described in the present invention is therefore a union of a hybrid network graph with a context graph. The dynamic interaction between the hybrid network graph and the context graph are affected through the energy minimization (entropy maximization) of the connecting edges between context nodes and network nodes. It should be noted that the connecting edges represent the small world connections described by the flow model, thus reducing the complexity of training and computation. The energy minimization values align the context-free space with the context by quaternion. The interaction of the network graph and its context may be used to impart information to the system in two modes. First, flows through the network affect the structure of the network graph. Second, flows between the context-free space and the context space affect the structure and its relation to the context. From those properties, useful outcomes of the invention include:
The ability of the software and computer system to organize and reorganize data algorithmically into a configuration that embeds information which may be hidden to the observer.
The ability to identify patterns from clustering of the network graph in regions described by the context.
The ability to identify patterns of small world network characteristics within the graph.
The ability to embed, refine, and extract information to and from previous data given a model or pattern embedded on a context.
The ability given to the practitioner to quickly and easily navigate the networks that relate and represent complex information.
The ability to simulate dynamic behavior within and about the network graph and its context.
The ability to identify areas of complexity by the behavior of the system.
The ability to categorize certain metrics and their associated errors from system behavior.

As previously stated, the networks created by this engine may include a hybrid of digraphs, bond graphs, and neural networks that ultimately represent computational models of systems. Changes in the network graph over time are attributed to a change in their position, relationships, and information content, representing what the system has learned (at least in some sense of the word). This change is manifest in the network in a manner similar to bond graphs, which have been used to model and simulate dynamic system behavior in the field of mechatronics. Learning takes place, therefore, from the changes in internal properties, shape, clustering, and diffusion resulting from the effects of the flow of various forms of energy into, through, and out of the network graph system. This is indicative of the dynamic behavior of the system. This means that the network learns from physical manifestations of dynamic behavior as integrated over time. The information learned is encoded in the structure and parameters of the structural elements comprising the graph.

Within the computer hardware, the structure of the network graph representation resides in computer memory, and may be thought of as a multiply-linked list of objects containing various properties of state and methods of behavior. Thus, the foundation for the network graph commences in the object structure.

Computer-human interaction may be conducted through a series of graphical user interfaces (GUI) that represents the system as some form of network graph structure with nodes placed in various locations. Alternatively, text file definitions, or audio-visual input may be processed to incorporate data in the network graph structure. When all information about a system resides internally, or within the network graph, this graph is considered “contextfree” [Engelfriet and Oostrom, Logical description of context-free graph languages, JCSS: Journal of Computer and System Sciences 55 (1997).]. This hybrid network, its components, vertices, edges, and context may be constructed n-dimensionally. Dimensionality beyond the ability of the representation medium may be reduced by reciprocal homogeneous dimensions. Thus the resulting nodes and traces are drawn to the monitor by the 2 or 3-dimensional graphics kernel where relationships exist between the nodes.

In some viewpoints, these nodes and traces may be a traditional UML diagram, representing structure, state machines, interactions, activities, and configuration. In others, it may be a multidimensional line graph, network, or mesh that describes a product development process for a particular product. In this case vertices and edges may be defined by label. Finally, in other representations, the graph structure may be simultaneously represented as a hierarchical tree that may represent artifacts that document a system. More details of this network graph structure is discussed in other portions of this disclosure.

The training engine may start, in one embodiment of the invention, by creating a TrainingSet object and populating the training array with N sets of M parameter vectors. The parameters represent nodes on the context space surface. The methodology used is that of creating a 2 dimensional Self Organizing Feature Map (SOFM) and training it using a Kohonen unsupervised learning algorithm. The SOFM will be mapped to the context by the spherical mapping algorithm. Each iteration of the algorithm perturbs the combined network by offering a potential and frequency to the one-in, two-out network. Each iteration adjusts the quaternion to minimize the energy differential between the two output results. The output with the highest free energy efficiency above the specified minimum criteria is selected. The entire network is then recalculated and repositioned based upon thermal differences induced in the nodes given the adjustment of the thermal contribution of the edges. If the potential in the training set exceeds the capacity of any edge, then the potential and frequency reduce, the edges in the network reset, and perturbation iteration is run again.

The decisions on which computational model to use are made by differential determinations based upon: sufficiency of information in the data; a maturity measure associated with the data; a measure of entropy and energy required to extract the information; measures of determinism of the results; and transformation metrics. Whenever possible, the computations are those calculated using standard numerical analysis. When numerical analysis is not possible, non-analytical, graphical, or topological techniques may be employed to give as accurate an estimation of the local result as possible. In addition to the estimation, the best approximation of the tolerances or a probability distribution for error estimation may be given.

Concepts that lead to the construction and operation of the hybrid network engine start with the simple graph. The purpose of the graphic engine is to represent the graph, its vertices and edges in a visual form that imparts meaning to the user, and stores information regarding the relationships and behavior of the system. At the most fundamental level, the hybrid network is represented as a network line graph. The graph is composed of an embedding space, vertices, and edges. A more detailed explanation of the nature of graphs as used in the present invention is provided below.

Idealized, a graph G contains a set of vertices V that represent structure through the placement of the nodes, and a set of edges E that represent the traces, or relationships between the nodes. At this point, we may refer to nodes and vertices interchangeably, however we will subsequently refine this definition to differentiate between the two concepts. Similarly, we will differentiate between edges and traces.
G=(V,E)
Where:
V is a collection of vertices, V={v₀, v₁, . . . vₙ},
E is a collection of edges, E={e₀, e₁, . . . eₙ}, and
eᵥᵢ, vⱼ relates two vertices vᵢ and vⱼ that may be considered endpoints to the edge.

The present invention may handle directionality in myriad modes, depending on the specific purpose. For a navigational purpose, directionality is ignored in all dimensions, including the temporal dimension. In energy potential or flow modes, the direction may have meaning. For example, in a purely resistive edge on a continuous signal of constant potential, the heat generated is directional (attempting to achieve equilibrium from hot to cold), but the flow of energy is not. Henceforth, we will limit our description of traversal to the concept of flow. For potential values that do not technically “flow” through the graph but nonetheless appear at the vertices, we will treat such appearance as flow. If there is no directionality upon the edges of the graph, meaning that it is irrelevant whether vᵢ to vⱼ is a source or a target of flow, then the graph is termed undirected. If there is a meaningful direction upon the edge, say from vᵢ to vⱼ, then the graph is termed directed. A directed graph is also termed a digraph. One final general point, if an undirected graph has no cyclical loops presented by the edges, the graph is termed a simple graph.

The clustering coefficient of the graph, which is a measure of the network's potential modularity, is averaged over all vertices clustering coefficients:

$$C = \frac{1}{N} {\sum }_{i = 1}^{N} {C}_{i}$$

This property is stored as Graph.Cluster=C.
A graph may contain other graphs as a means for handling disjoint networks.
G={G₀, G₁, . . . Gₙ}
Where:
G represents a collection of graphs.

The vertices of the hybrid network are located in an n-dimensional embedding space. Vertices are located initially by an agnostic algorithm, eliminate the affects induced by the observer's meaning upon the graph configuration. This agnostic algorithm strictly relates placement with the relationships described by an edge without regard to vertex or edge characteristics. All meaning from the human observer's point of view (supervised) comes from the embedded networks position within the context space, and how that system is viewed by the observer.

There are several properties associated with vertices that are coarsely divided into fundamental and ephemeral classifications. Fundamental properties are directly part of the Vertex classifier, where ephemeral properties are stored in indexed arrays in the likewise ephemeral DrawGraph class. The first, and perhaps primary, characteristic of a vertex is its degree. The degree is characterized by the number of edge connections to neighboring vertices. For example, let vertex Vᵢ be connected to kᵢ neighbors:
kᵢ=count(E_{outgoing})+count(E_{incoming})
Where Kᵢ=Vertex.Degree

Derived from degree, the clustering coefficient measures the tendency of vertices to cluster in interconnected modules or groups within regions of the embedding space. The clustering coefficient Cᵢ of a vertex Vᵢ, is defined as: The total number of edges between these neighbors is at most kᵢ(kᵢ−1)/2. If the actual number of edges between these kᵢ neighbors is nᵢ, then the clustering coefficient Cᵢ of the vertex Vᵢ is the ratio:

$${C}_{i} = \frac{2 {n}_{i}}{{k}_{i} ( {k}_{i} - 1 )}$$

Where Cᵢ=Vertex. Cluster

Each vertex has a weight w, a duty cycle z, and a residual temperature t. After a perturbation event, the duty cycle reflects how many frequency cycles passed through that vertex divided by the total number of input cycles. This can be over 100%. The higher the frequency, the greater amount of heat generated by the complex component, which represents the reactance value of impedance.

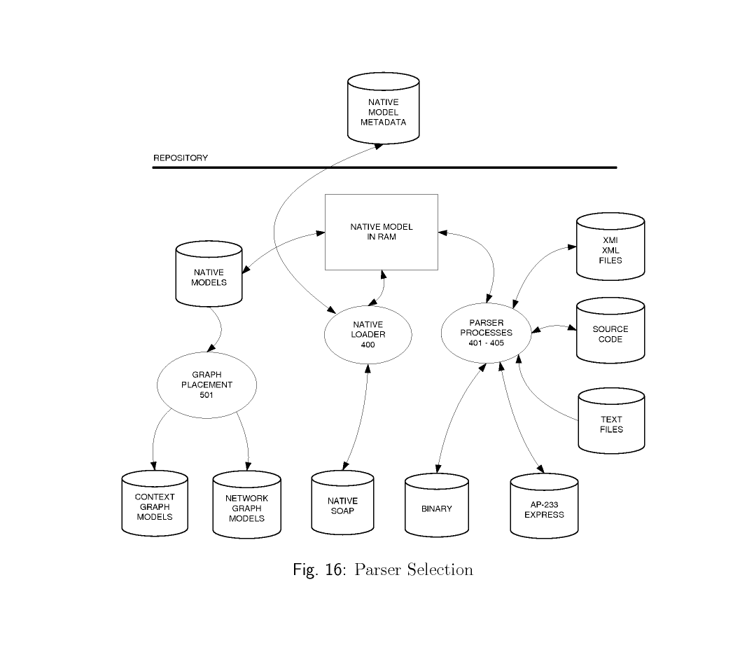

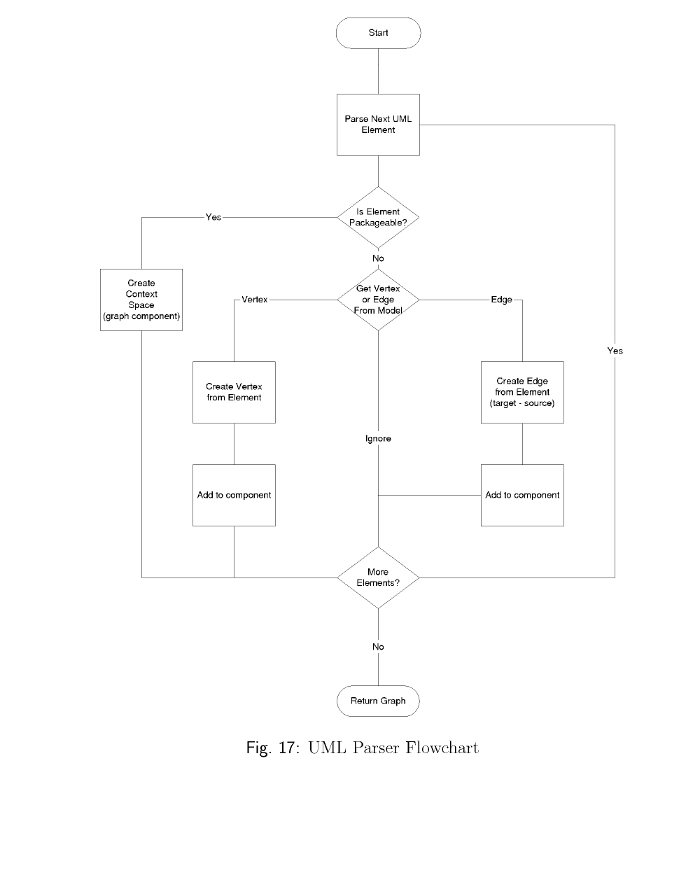

In addition to the standard vertex types as enumerated by Mosterman [Pieter Mosterman, Hybrid dynamic systems: Hybrid bond graph modeling paradigm and its application in diagnosis, PhD Thesis, Vanderbilt University, 1997.], presentation of hybrid bond graphs have two types of edge connections to a vertex, and this property is determined by the type of vertex. Type A (FIG. 16) is a proportional vertex, where the flow or potential is outwardly directed through all ports simultaneously according to that port's proportionality. The other type of vertex is stochastic, meaning the Type B vertex (FIG. 17) is a mutually exclusive probabilistic vertex. Flow through this vertex selects one of the outgoing paths by random selection based on p the probabilistic parameter.

Edges are another boundary condition that is relevant to the methodology of the present invention. Let E be a collection of edges E={e₀, e₁, . . . , eₙ}, and edge eᵥᵢ₊ᵥⱼ is a tuple where i and j are indices to the source and target vertices respectively.

If this direction is meaningful, a Boolean parameter is Directed is set to true. For undirected graphs, source and target have no meaning, and is Directed is set to false.

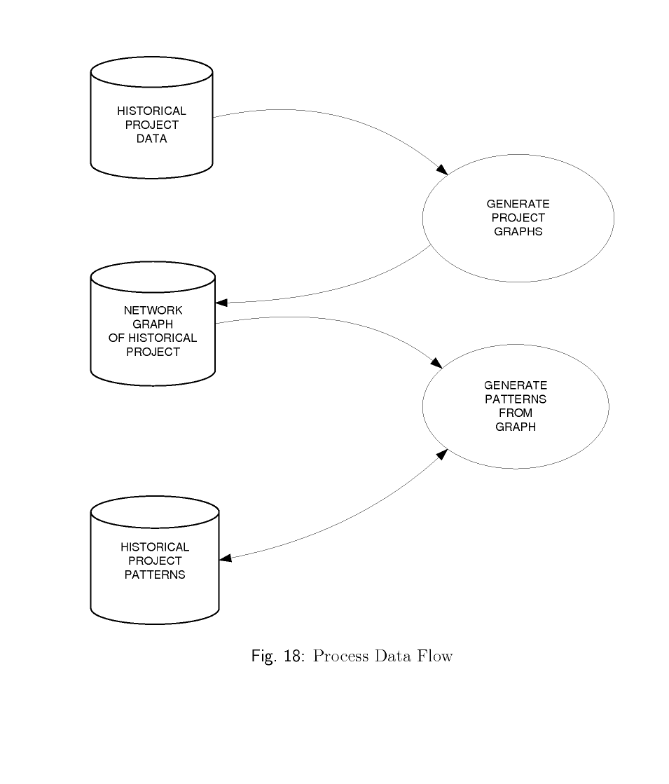

The first edge characteristic is the average distance (geodesic) between two vertices, where the distance d(i, j) between vertex vi and vj is defined as the number of edges along the shortest path connecting them. For example, in FIG. 18, the distance between vₒ and v₉ is 2, and the distance between V₅ and v₉ is 4. The characteristic path dist d_{CP} is the average distance between any two vertices:

$${d}_{CP} = \frac{1}{N ( N - 1 )} {\sum }_{i \neq j} {d}_{ij}$$

Where
d_{CP}=Edge.DCP The characteristic path distance

The fourth edge characteristic is the weight w of the edge (cf. Vertex weight) which is characteristic of the average capacity of flow with the analogy to average current I in a mechatronic circuit.

The fifth edge characteristic is its instantaneous capacity Iᵢₙₛₜ, with the analogy to instantaneous amperage, or

$$\frac{ⅆ E}{ⅆ T}$$

in a mechatronic circuit. When this capacity is exceeded, the edges performs a “self cut,” discontinuing flow. This triggers a Boolean is Cut to be set to true. Edges have a Reset ( ) function that restores operation.

The sixth edge characteristic is the impedance Z. Impedance is characterized by both resistance R, and reactance properties X, where resistance constrains free energy, and reactance generates heat as follows:
ZεC

$$Z = \sqrt{{R}^{2} + {X}^{2} i}$$

$$I = \frac{E}{\sqrt{( {R}^{2} + {X}_{l c}^{2} i )}}$$

$${X}_{l c} = {X}_{c} - {X}_{l}$$

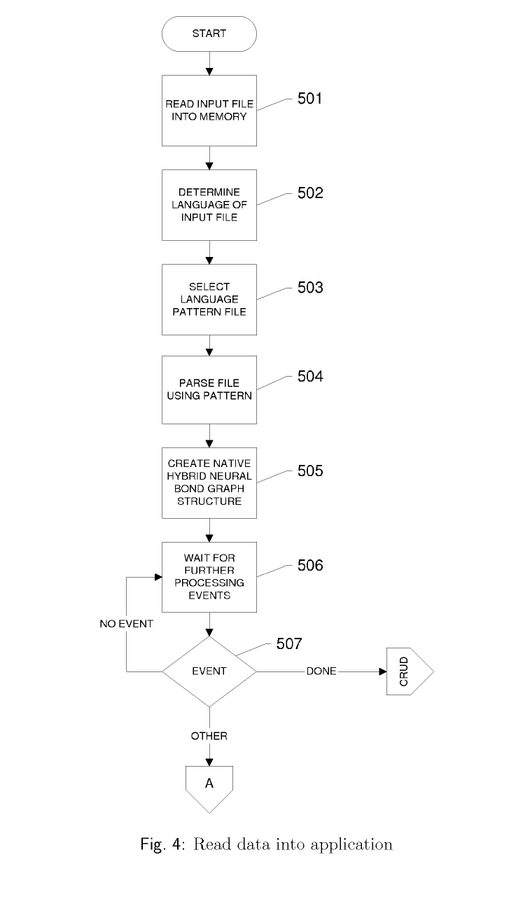

A network edge can be configured to handle frequency in a variety of ways, but a general implementation is a simple L (see FIG. 4) that creates capacitive reactance and converts energy to heat. For example, in modeling the capacity of a job function, the capacitive reactance sinks energy when a high frequency of repetitions is demanded of a worker. There comes a point of saturation when frequency is the constraint that limits the worker's capacity.

$${X}_{i} = 2 π f l$$

$${X}_{c} = \frac{1}{2 π f c}$$

Patterns are a graph condition that is relevant to the methodology of the present invention. P:PₓεE The patterns are determined by the actual path navigated through the graph by traversing the edges connecting the vertices in the pattern in order of connection. The pattern becomes an alphabet of edge indices that we will use for undirected navigational purposes, development of training sets, and data graphs. The graph G, vertices V, edges E, and patterns P provide the primitives for data structures in the present invention.

The decisions which computational models use are made by differential determinations based upon: Sufficiency of information in the data; A maturity measure associated with the data; A measure of entropy and energy required to extract the information; Measures of determinism of the results, and Transformation metrics.

Whenever possible, the computations are those calculated using standard numerical analysis. When numerical analysis is not possible, non-analytical, graphical or topological techniques is employed to give as accurate an estimation of the local result as possible. In addition to the estimation, the best approximation of the tolerances, or a probability distribution for error estimation is given.

A classification of this continuous measuring space is represented by the hierarchical histogram as follows:

| Replication | 0.0 ≦ value < 1.0 |
|---|---|
| Algorithmic | 1.0 ≦ value < 2.0 |
| Heuristic | 2.0 ≦ value < 2.0 |
| Judgmental | 3.0 ≦ value < 3.0 |
| Random Walk | 4.0 ≦ value < 5.0 |
| Random | 5.0 |

The method of the present invention works by applying this physical analogy to models of information about systems. These information models may be represented by a native language such as a serialized binary, a standard computer language such as Java or C#, a standard data transfer language such as XML, XMI, SOAP, DOM; or written in some formal language such as the Unified Modeling Language (UML), the Systems Modeling Language (SysML), DIMACS format, GraphML, AP-233; or other natural language consistent with the input, crawler or parser translation capabilities of a particular system. These are converted into a standard typed format for processing by the parser function into data and metadata components. From the common graph data structures, many types of graphs may be created, depending upon the amount and classification of data provided. Additionally, any one graph may have several uses.

For example, in an UML static structure diagram nodes represent classes that are connected by edge relationships, such as Generalization, Association, Aggregation and Composition. Navigable relationships represent the calls to the properties and methods associated with those classes, resulting in a call graph. Generalization represents a directional evolutionary path from primitive to complete classes.

Other graph constructs consist of, but are not limited to object creation, class development paths, requirements fulfillment networks, reference relationships, code pattern application, and development pattern application.

The physical analogy works as follows: a graph of the system under observation is created in the system memory. The layout of the graph is calculated by the computer using an extension of well understood force directed energy minimization (entropy maximization) calculations such as those of Fruchterman and Reingold (FR) [Thomas M. J. Fruchterman and Edward M. Reingold, Graph Drawing by Force-directed Placement, Software—Practice and Experience 21 (1991), no. 11, 1129-1164.], Eades [G. di Battista, Peter Eades, R. Tammassia, and I. Tollis, Graph drawing: algorithms for the visualization of graphs, Prentice Hall, New York, 1984.], Harel and Hadany, Kamada and Kawai (KK). The force directed method used in the present invention are expansions upon algorithms such as those detailed by Gajer and Korbourov, utilizing a combination of FR and KK methods as explained in their Graph dRawing with Intelligent Placement (GRIP) [Pavel Gajer and Stephen G. Korbourov, GRIP: Graph Drawing with Intelligent Placement, Journal of Graph Algorithms and Applications 3 (2002), no. 3, 203-224.] method for the ability to place large number of nodes in computationally short O(log n) time. The metrics obtained are based upon well known Boltzmann probabilities and clustering algorithms, and descending degree sorting. Using forward and inverse calculations, the adjustments to the placement are made according to an algorithmic schedule.

$$\begin{matrix}Boltzman Probability \\ exp = {ⅇ}^{- \frac{E ( {x}_{l} )}{kT}} & ( 5.1 ) \\ Boltzman Distribution \\ \frac{{v}_{x}}{V} = \frac{{ⅇ}^{- \frac{E ( {x}_{l} )}{kT}}}{{\sum }_{x} {ⅇ}^{- \frac{E ( {x}_{l} )}{kT}}} & ( 5.2 ) \\ Monte Carlo \\ < A >= \frac{1}{Z} \int A ( x ) {ⅇ}^{- \frac{E ( x )}{kT}} ⅆ x & ( 5.3 )\end{matrix}$$

Where
<A> is the average property of the vertex state
k is the Boltzmann constant 1.38065×10⁻²³ joules/° K e 2.718281828
T is the temperature of the vertex state in ° K
dx is the change in location (vector) of the vertex
Remember that a joule is 1 Watt-Second or 1 Newton-Meter

$$< A >= \frac{1}{Z} {\sum }_{l = 1}^{M} A ( x ) {ⅇ}^{- \frac{E ( x )}{kT}} \qquad ( 5.4 )$$

The complete Monte Carlo

$$< A {>}_{est} = \frac{{\sum }_{l = 1}^{M} \frac{A ( {x}_{i} ) {ⅇ}^{- \frac{E ( {x}_{l} )}{kT}}}{{P}_{samp} ( {x}_{l} )}}{{\sum }_{l = 1}^{M} \frac{{ⅇ}^{- \frac{E ( {x}_{l} )}{kT}}}{{P}_{samp} ( {x}_{l} )}} \qquad ( 5.5 )$$

After canceling out the Boltzman factors

$$< A {>}_{est} = \frac{{\sum }_{l = 1}^{M} A ( {x}_{l} )}{M} \qquad ( 5.6 )$$

Partition function

$$Z = {\sum }_{n = 1}^{x} A ( x ) {ⅇ}^{- \frac{E ( x )}{T}} \qquad ( 5.7 )$$

The Bayesian formulation of the Inverse Problem [Klaus Mosegaard, Resolution Analysis of general inverse problems through inverse Monte Carlo sampling, Inverse Problems 14 (1998), 405-426.]

$$σ ( x ) = C \frac{ρ ( x ) θ ( x )}{ρ ( x )} \qquad ( 5.8 )$$

These are further extended by adding a temporal context (time) in a manner similar to GEVOL [Christian Collberg, Stephen Korbourov, Jasvir Nagra, Jacob Pitts, and Kevin Wampler, A System for Graph-Based Visualization of the Evolution of Software (GEVOL), Tech. report, University of Arizona, Tucson, Ariz. 85721, 2002.] but extended to a continuous temporal domain, and the frequency in which object or signal pulses traverse, eddy, or flow through the graph.

The above procedure yields a context free graph that may be explored for its clustering and small world network properties that will be used for navigational purposes. The navigational meta-graph is constructed in-between clusters identified by high degree vertices near the barycenter of the cluster, and the shortest path between these highest degree cluster nodes. A similar calculation is between a randomly selected leaf node in each cluster for construction of a special “short circuit” edge, thereby creating a small world network.

A novel aspect is the addition of a possibly hyper-dimensional “context box” graph constructed by using similar methods described above within which the above graph may be mapped. This creates a “graph-in-a-box” (or graph-in-a-ball if Riemannian constructs are used). Again, using energy minimization, the graph may be aligned to sparse mappings on the context surface(s) using manipulations to a virtual quaternion trackball by using the barycenter, a vertex point, its displacement, and the total energy change.

The resources may be characterized as having the capability and capacity to generate, consume, accept, reflect, store, transform, and transfer energy in some combination. Capability and capacity are modeled on orthogonal meaning spaces. Capacity limits capability and can be considered analogous to impedance (resistance and reactance) in a mechatronic system [Pieter Mosterman, Hybrid dynamic systems: Hybrid bond graph modeling paradigm and its application in diagnosis, PhD Thesis, Vanderbilt University, 1997.].

The physical analogy as that the pulse represents energy, and the graph, its context, and time represents a mechatronic system through which energy flows of various efficiencies resulting in work (motion or pressure) or heat. At this point three graph models of the system are available: (1) graphs that reposition over time due to force and simulated annealing, (2) bond graphs, and (3) a combination of (1) and (2). Furthermore, the context graph may be adiabatic, wherein the heat of the context raises with the thermal properties of the graph of the system under observation.

The context box may also be used to model external forces into the system under observation. These may be simple force and temperature environments, represented by changing the contour topology of context environment, using Ising or Potts models, or Transfer Theory constructs. The pulse and paths traveled are measured over several iterations creating frequency spectrums. The higher the frequency implies a higher level of energy as will be explained in detail later.

The graph structure above is used iteratively by the application in the following (generalized) ways: (1) To link the data stored within the system in a free-form way that allows the context space to structure data into possible knowledge patterns. The resulting graph becomes the foundation for the navigation. (2) To link ontologies external to the system with the internal data to facilitate communication between heterogeneous disciplines. (3) To compare, analyze and identify recurrent paths (patterns) used in product development and the product development process. (4) To measure energy flows throughout the graph as an indicator for the amount, efficiency and effectiveness of “work” and “flow.” (In the bond graph analogy, this may be considered an impedance transformer). (5) Comparisons using Inverse functions [Klaus Mosegaard, Resolution Analysis of general inverse problems through inverse Monte Carlo sampling, Inverse Problems 14 (1998), 405-426.].

An embodiment of the system and methods of the present invention includes the hardware and software applications stored within the storage media, and are described below with references to the drawings in the attached figures. This represents one embodiment of many possible combinations.

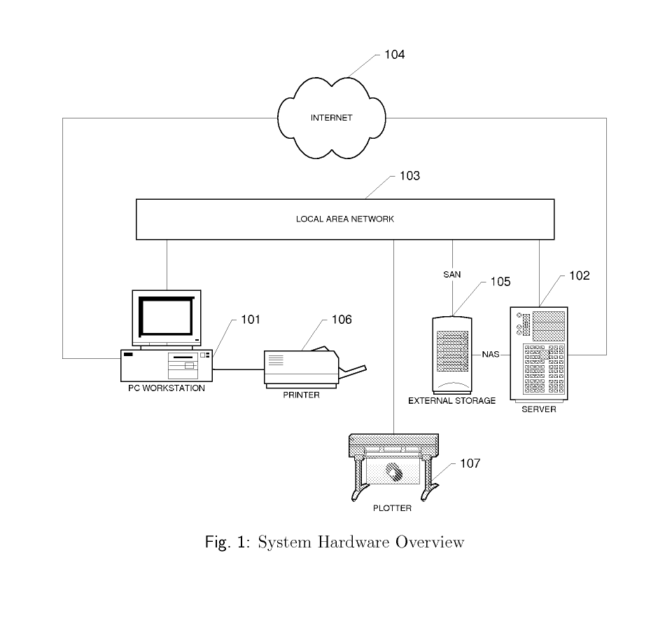

The hardware system (FIG. 1) consisting of personal computer (PC) workstation (101) is connected to server computer (102) through local area network (103), or wide area network or internet (104). The server may have an internal storage device, or external storage from a storage area network, or network attached storage (105). Printer(s) or plotter(s) may be directly attached (106) to the server or workstation, or attached to the local area network (107).

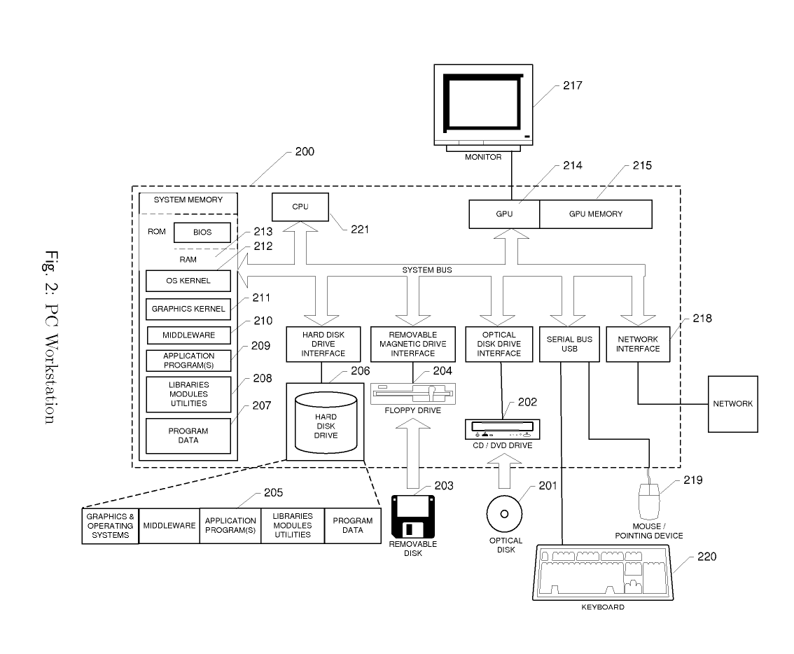

PC workstation (200) is shown in FIG. 2 and is fitted with monitor (217) and graphics card (214) that supports graphics pipeline functions using either dedicated graphics memory (215) or shared system memory (207). Workstation (200) is controlled by a pointing device such as trackball or mouse (219) and keyboard (220). Workstation (200) is connected to a network through a network interface card (218) to network (216) that allows communication with the server, described above. Internal storage device (206) holds the required client side application, modules, libraries, utilities, and data (205).

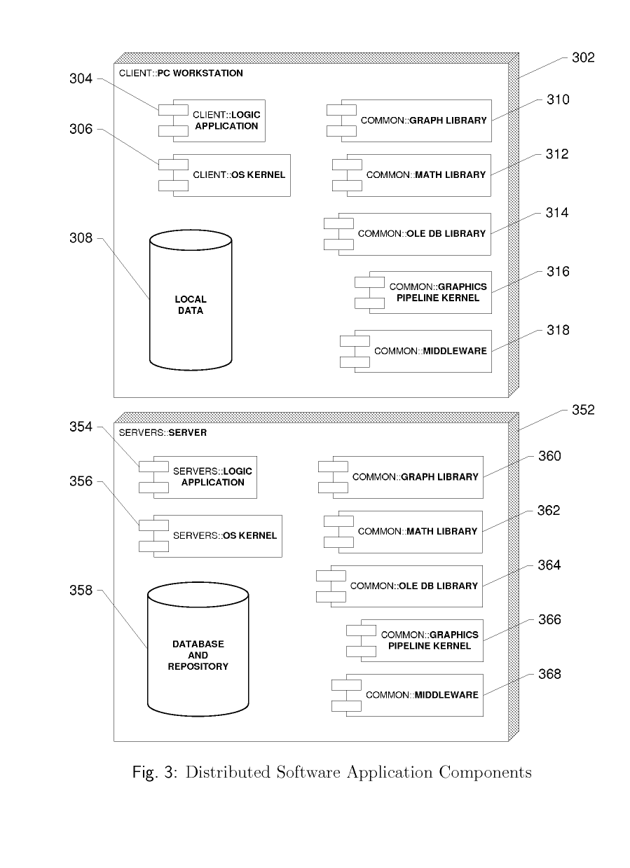

The data, program applications, libraries, modules, utilities, middleware, graphics kernels and operating system in this embodiment are installed as shown in FIG. 3 to the internal storage of the PC workstation (302) and the server (352) from an optical drive as shown in FIG. 2 (209) through an optical disk medium (201) such as a CD-ROM or DVD (202).

Referring to FIG. 3, the PC workstation runs on an operating system (306) such as Windows or Linux. The middleware (318) necessary to run the application consists of Microsoft .NET for Windows, or Mono for Linux. Additionally, a graphics kernel (316) is required such as DirectX for Windows, or OpenGL for Linux, which is necessary for operation of the graphics display pipeline. Installed on workstation (302) is client software application (304) which consists of a graphical user interface and main logical group, for example WattWorks. The application installer contains redistributable middleware for installation, if necessary. The required libraries installed on the workstation are the graph library (310), mathematics library (312), language libraries (320) which may include the UML library, SysML library, and parser and/or comparator library. This embodiment illustrates the possible use of certain third party graphics applications such as Microsoft Project, Microsoft Visio and Microsoft Visual Studio for illustration of functionality, but which are not a necessary requirement for the basic functionality of the invention. Windows, DirectX, .NET, SQL Server, Visio and Visual Studio are trademarks of Microsoft Corporation, OpenGL is a trademark of Sun Microsystems, and WattWorks is a trademark of Watt Systems Technologies Inc.

Installed on the server (352) is an operating system (356) such as Windows or Linux and the required middleware (368) along with the server-side application (354) and libraries (360) (362) (364). Also installed on the server is a database management system (DBMS) (358), in this case MS SQL Server which also provides the metadata repository.

Referring again to FIG. 2, upon invoking the application on the workstation, application software (205) is read in from the hard disk (209) and loaded into system memory (209), and then executed as a process in CPU (221). Other required processes such as the graphics kernel (211) are dynamically read in from storage, loaded into memory and invoked as required by the middleware layer (210). The middleware also handles module loading, unloading, memory management, garbage collection functions, and just-in-time (JIT) compilation of assemblies created by Meta Object Facility (MOF) factories either on the workstation, or as process threads on one or more servers.

The data and instructions in the workstation or server system may be cached by the operating system in RAM (216), in temporary storage in the CPU's chipset, or on the hard disk (206). At various scheduled times, or upon saving or exiting, the states of work product objects are serialized and stored in temporary files on the hard disk (206).

This embodiment illustrates the use of certain third party graphics applications (313) such as Microsoft Project (320), Microsoft Visio (321) and Microsoft Visual Studio (322) for illustration of functionality, but which are not a necessary requirement for the basic functionality of the invention.

Installed on server (350) (FIG. 3B) is an operating system (306) such as Windows or Linux and required middleware (314) along with server-side application (350) and libraries (352) (353) (354) as detailed for workstation 200. Also installed on server (305) is database management system (DBMS) (307), in this exemplary embodiment is MS SQL Server which also provides metadata repository (307). In this embodiment, graphics pipeline kernel (357), for example MS Project Server, is run on server (350) and may be integrated into DBMS (307).

Upon invoking the application on the workstation, application software (205) is read in from hard disk (206) and loaded into system memory (222), and then executed as a process in CPU (221). Other required processes such as graphics kernel (311) are dynamically read in from storage, loaded into memory and invoked as required by middleware layer (314). Middleware (314) also handles module unloading, memory management, garbage collection functions, and JIT compilation.

Assuming a clean slate installation with no prior models, data from reliable sources is ordered and imported into the system. A reliable source is one that may be validated either prior to or subsequent to imparting the data. The internal data structures provide for planned and actual historical data. For example in this embodiment, the data from an existing MS Project data source is imported from the server and analyzed into phases, elaborations, iterations, and activities. Internally, the data structure for process data is stored in RAM data area(s) (213) shown in FIG. 2. As in most GANTT or project management linear time lines, phasic and iterative patterns may need to be initially identified by the practitioner.

Artifacts representing the product developed by the process above are related to the system through the application. Examples of artifacts are requirements, reference material, drawings, specifications, source code, UML or SysML models, performance charts, histories, notes, etc. These artifacts are stored in the server storage area and references to that resource are included in the data structure. Artifacts temporarily stored on the workstation are replicated to the server by a background utility.

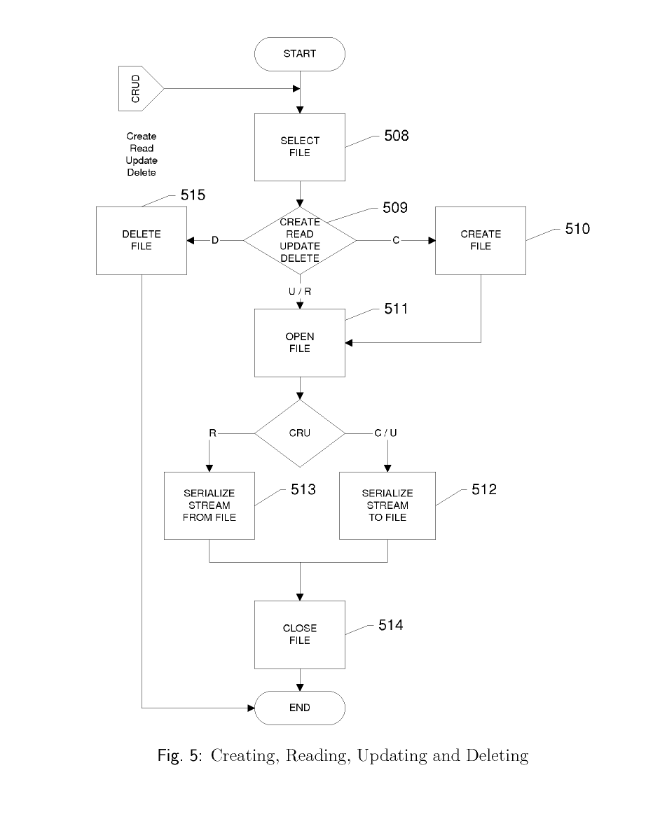

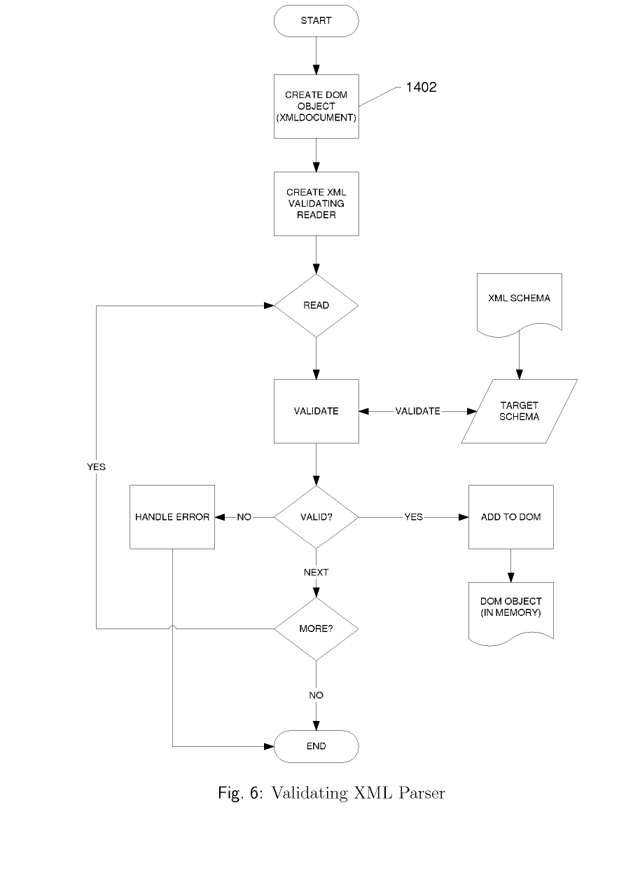

Hybrid Network System Graph from Existing Data. Referring to FIG. 4, model data extant external to the computer workstation is encoded in some optical or magnetic media (files), or as electronic signals sent across a computer network (streams). The format of those encodings, in one embodiment of the invention, is either (1) an Extensible Markup Language (XML) format (402) such as XML Metadata Interchange (XMI) or AP-233/Express format [ISO-10303-11] (408), (2) a Standard Object Access Protocol (SOAP) format (412) consistent with 1), or 3) a binary format (410) consistent with 1). The files are created, read, updated, and deleted as shown in FIG. 5. The selection of the file (508) is accomplished by using a GUI dialog box. A buffer referred to as a stream reader is used to serialize (512) or de-serialize (513) data to or from the file or incoming network stream.

Data processing from a file or stream into a DOM. The stream reader then parses the incoming data according to its metadata into a Document Object Model (DOM) object in memory. There are several types of stream readers which may be used in the application, such as binary, text, SOAP, or validating XML, which are selected by examining the file extension. Upon completion of the operation, the logical file is closed (514) and a populated DOM object now exists in memory.

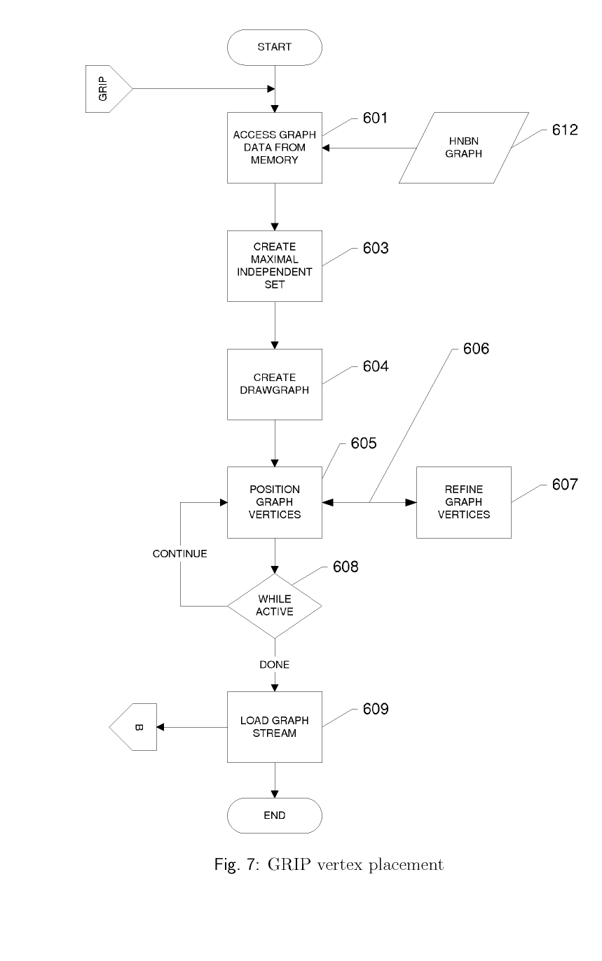

DOM processing from XML/XMI files. For example, referring to FIG. 7, using XMI with a standard XML parser library (e.g., Apache Xerces or Microsoft MSXML), the data is de-serialized into a Document Object Model (DOM) object (720) created in the workstation system memory and validated against an XML schema (714) using a validating XML stream reader (706-712).

DOM processing of Petri-net files. Data from UML Activity diagrams is MOF mapped from the DOM onto a hybrid network graph as nodes that represent classifiers of specific behavior. The Action nodes are represented as functional transition nodes to be MOF mapped onto the edges represented in the graph as a node with incoming and outgoing relationship edges. DOM Petri-nets are similarly MOF mapped as HN objects, where the transition nodes are encoded as HN edge properties.

DOM processing of Harel State-Chart and automata files. Data from UML State Machines or Harel State-Charts are encoded in a manner similar to that above as specific states (also referred to as places) using MOF metadata in conjunction with a MOF factory method as HN network nodes and transition edges. Note that the properties and methods representing the actual behavior of transition edges are separated concerns from coupling relationships between nodes (c.f UML Superstructure reference to Classes.Kernel.Relationships).

Translation of DOM object to native graph objects. A separate thread of execution or process is spawned in the server (352) for manipulation of the object states. The data in the DOM (720) is then parsed and encoded into a native, object-oriented (O-O) system graph model which is most often a HN graph embedded in this process thread. The native objects are created within the server memory by a MOF meta-model factory upon the metadata, using reflection and late-binding methods of the middleware. The model nodes are represented as hybrid network (HN) vertices, and the relationships are represented as HN coupling edges.

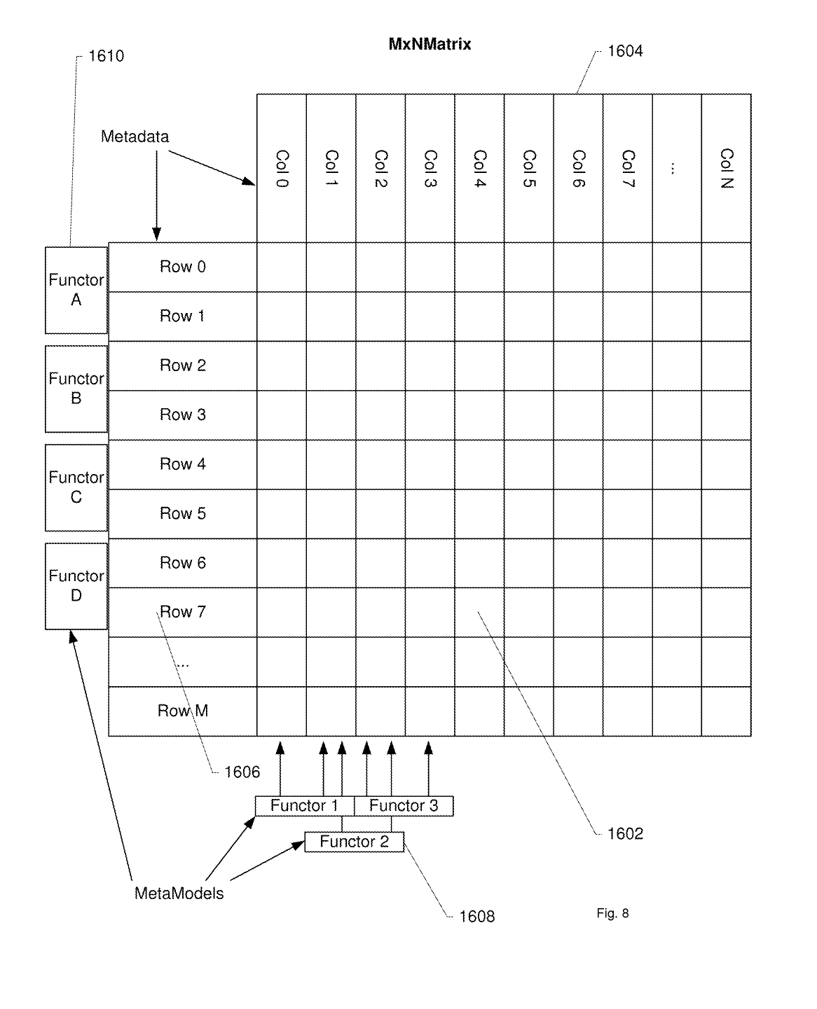

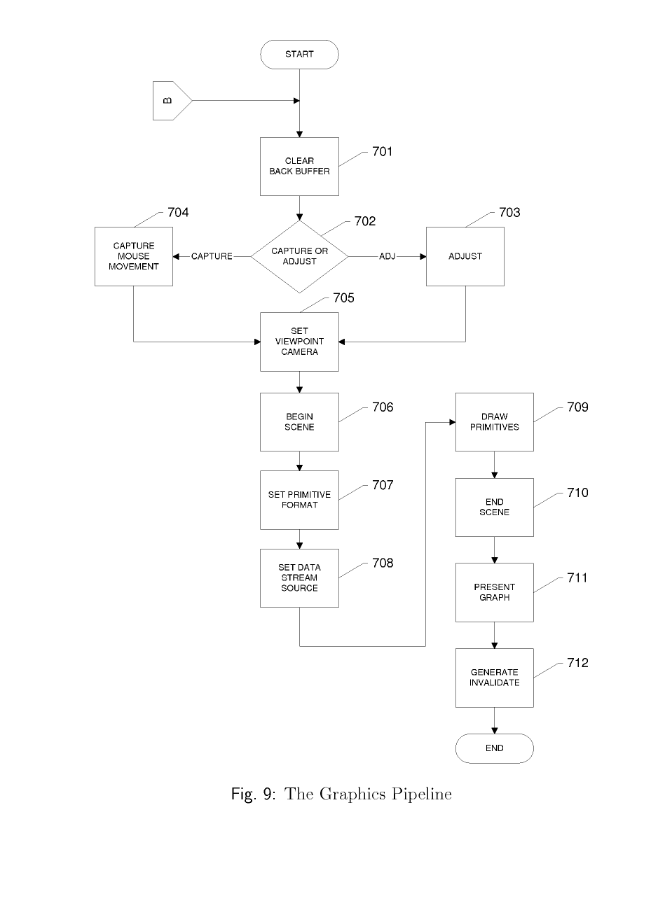

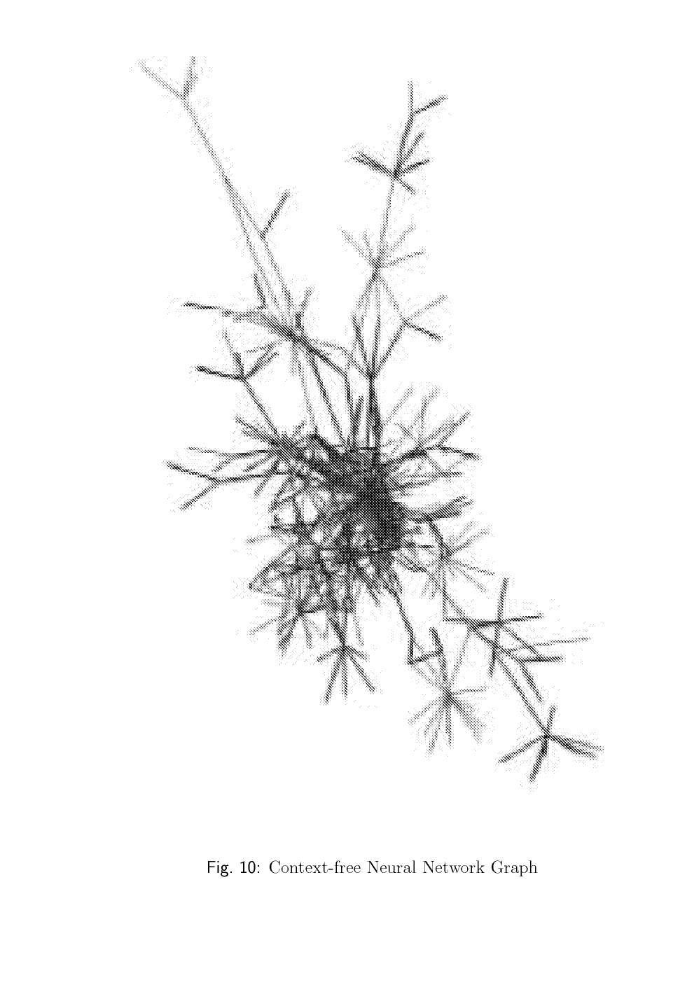

Encoding information upon data. Data is encoded in vectors, matrices and multi-dimensional typed arrays as shown in FIG. 8. Metadata encodes information about the data. For example, each column in an array may have a name, such as a variable name (1604), where the data in that column (1602) represents a value for that variable. Similarly, each row may have a name, such as a sample number on a discrete time schedule (1606).

Data in the rows and columns of matrices (for example) may be coupled, but often there is no metadata specifying how the rows are related to other rows, the columns are related to other columns, or even how the columns and rows are related. To address this problem, Functor classifier (1608) provides the functional mapping properties between categories, if such mapping exists. If there is no mapping between categories, or if the nature of such mapping is unknown, a functor may be null value. Functors may represent simple relationships, such as time intervals, or complex relationships such as iterated function maps (functors of functors). In the exemplary embodiment shown in FIG. 8, the functors between the rows (1610) might represent the statistical dispersion of the data vector. A significant property to the functor element is that functors are represented as nodes on the Context Graph, and that the Context Graph relates information in complex ways.

Thermodynamic architecture of graph elements. Referring to FIG. 11, once the HN graph has been populated with the inclusion of the vertices and edges existing in a native O-O representation in memory, the nodes and edges comprising the graph may be positioned algorithmically by use of the Graph Library (GraphLib) component, using an agnostic Graph dRawing with Intelligent Placement (GRIP) method. As outlined in FIG. 8, the graph vertex representation of graph nodes are arranged in Maximal Independent Set Filtrations (MISF) (603) by using a Breath First Search or Dijkstra algorithm according to the significance of lengths of the edges to their nearest neighbors. The vertices are placed according to their locations in the MISF. The process uses a Metropolis-Monte Carlo method in conjunction with a combination of simulated annealing and force directed displacement to place sets of vertices around a common barycenter. The process may be iterated until the annealing temperature falls below a specified level.

Creation of the Context. The creation of the Context may be accomplished by instantiating a Context object based upon the Context classifier. The classifier provides reference variables to objects that represent the Context Space, the Environmental Space, the Context Graph, and the Interfaces to the Hybrid Network Graph. It also supplies reference methods, either directly or indirectly, to manipulate the states of those objects.

Creation of the Context Space. The Context Space object may be instantiated based upon the ContextSpace Classifier. The Context Space provides the framework structure for interaction with a context-free HN system model graph. In this regard, it provides a measuring space that may be used to quantify realizations on conceptual dimensions as meanings in time. This may be accomplished by first establishing a temporal component object consisting of a wave-function that creates a unit cycle and a timeline. In one embodiment of the present invention, the timeline is an extension of the Spinor classifier.

The spinor, being an extension of the Functor classifier, is a novel object formed by instantiation of the Spinor classifier that provides information about dimensional coupling and emergence missing in the positional placement of data between the rows of a vector or rows and columns of a matrix, or its metamodels.

We construct dimensions of the context space by a form of “addition” of spinors. For example, when we add a column to a matrix, we are adding a dimension to that matrix space. Similarly, when we a a matrix to a matrix space, we are adding a dimension to the matrix, making a multidimensional matrix. This mathematical simplicity belies the informational component of the physics of interaction.

For example, this method enables building up the context from first principles to a desired level of completeness in the description of concepts surrounding the system. This starts with the fundamental dimension of time. The timeline is a nonlinear spinor object with a unit normal vector at some position x on the timeline that revolves about the instantaneous tangent to the axis at some unknown rate r=θ/τ. A wavefunction ψ establishes the rate r and a propagation rate R=∂ψ=∂τ of position x and its associated revolution normal toward the future. We arbitrarily construct a D¹ line Z tangent to point x where Z⁻ is viewed from point x as the depth-past, and Z⁺ is viewed from X as depth X future. The precession of the line defined by the slope of the normal vector defines the past and future lightcones at x which represents the D⁰ point NOW.

The spinor relates dimensions in spacetime by rotation about imaginary axes such as i; j;& k axes in three dimensions, where i²=j²=k²=−1. Spinor rotation has a complex component that changes handedness, thus the direction of the normal in a complex space. This is “counted” through (π) rotations as a parity property representing real and imaginary components of a complex number. The spinor connections between dimensions is manipulated for viewing by quaternion, as further detailed in Manipulation of Graph Model Objects, below. Spinors are used to relate new dimensions or degrees of freedom orthogonally to one or more existing dimensions.

We now use a spinor to project a line Y at x orthogonal to line Z along the timeline normal. The Y axis represents width. If we now examine the spinor normal between the coupling of width X depth X past we may use yet again a spinor to project height, which we see is orthogonal to both width and depth. As we add dimensions, we see the spinorial normal procession with respect to orthogonalities may be specified according to A×B×ˆn (ˆn representing the revolution normal).

The above context construct represents a spacetime primitive that may be expanded and logically merged with other n-dimensional spaces. If the context has a gravitational association, the concept of down may be defined by a unit vector in the Y⁻ direction, therefore up would exist in the Y⁺ direction. This is added to the metadata as a Property of the Context Space of type Vector4, named “up” with the parameters of float[ ] 0, 1, 0, 0. It is realized my the MOF factory using reflection and late binding as:

Vector4 up=new Vector4(0.0f, 1.0f, 0.0f, 0.0f)

Having thus created a primitive spacetime context, we may proceed to define and add other concepts upon the context, as illustrated in the Creation of the Context Graph. Subgraphs that represent meanings not yet applied may be created at any time and added to the components collection of the graph object. When the orthogonality of their coupling(s) become known, they are added by a spinor object.

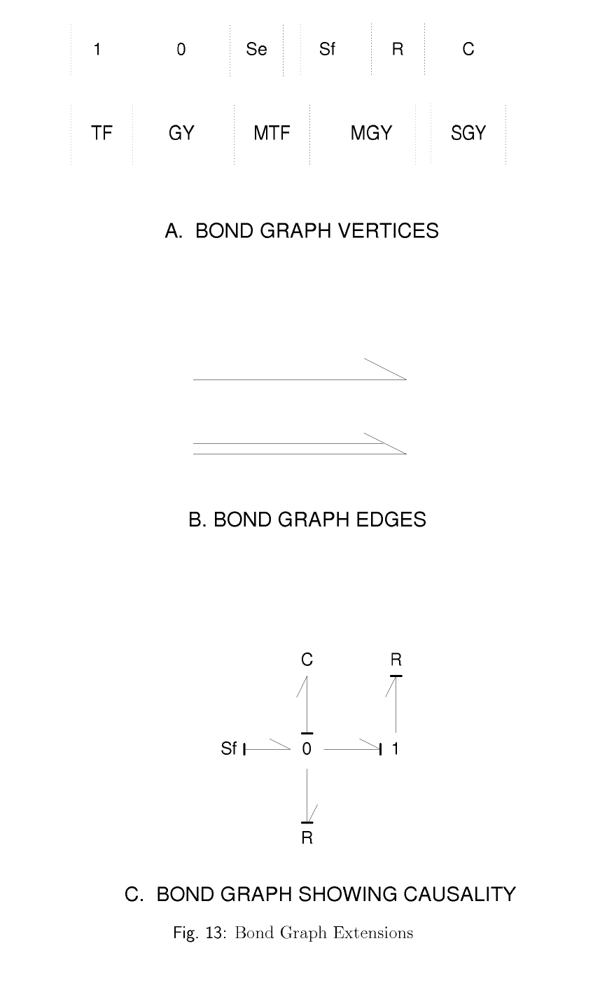

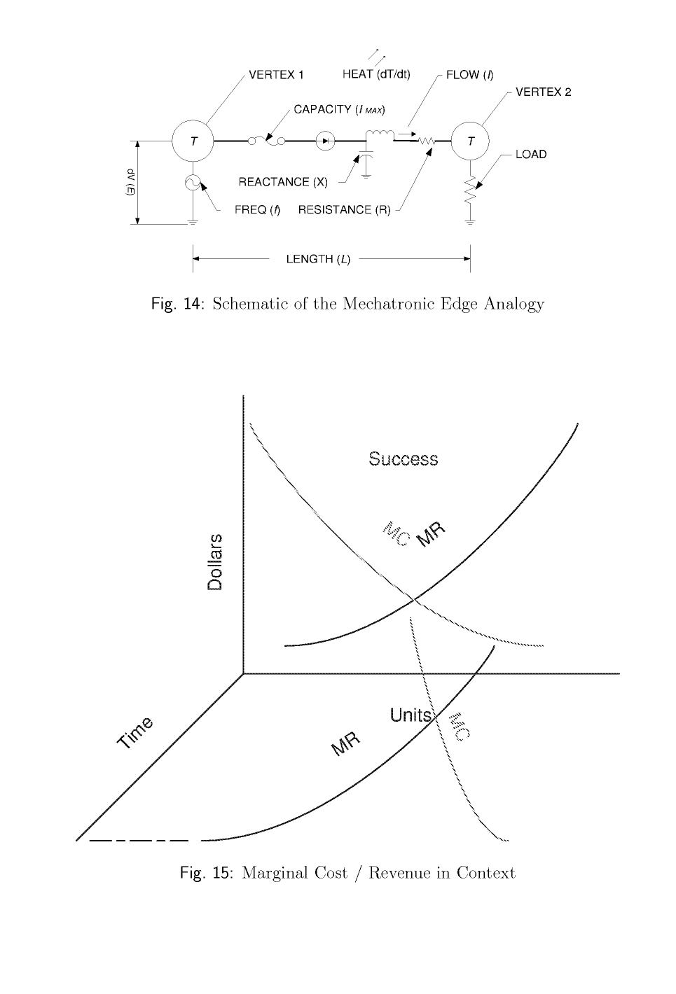

For example, referring to FIG. 13, a criteria for “success” may be developed as a region where marginal revenues equal or exceed marginal costs. To create this context space, we create a spinor object that “spins” a dimension of “value” ($) orthogonal to time from the temporal domain in the context, and from the unit cycle component of our temporal domain. We may create a functor that relates marginal cost and marginal revenue to value and units. We shall use the variable “success” as a criterion for evaluation of a complex configuration of an enterprise given an environment of changing market conditions.

Creation of the Environmental Space. The Environment Space object may be instantiated based upon the EnvironmentSpace classifier, which is a subclass of the ContextSpace. The meanings of the properties of the Environmental Space add such concepts as Pressure, actual ambient Temperature, Value and Weight to the volumetric and temporal properties of the primitive Context Space.

In our example, we may wish to train our Artificial Intelligence engine based upon what our suppliers and competitors have done in the past to develop the dynamic functors over time, or we may elect to develop mutatable dynamic response to their evolutionary behaviors. If we do the latter, we will create many plausible models, that will need forward and inverse refinement, but we will have developed a robust and survivable set of alternatives based upon “complexification” of our situation.

Creation of the Context Graph. The relationship between the Context Space and the Context Graph represents the coupling of concepts in a unique mereological manner. A concept has a location that only makes sense when located in the Contextual Space, and subjected to measurement. Thus, a meaningful concept exists in a region defined on some combination of dimensions.

Creation of the Interfaces. Interfaces are merely nodes on the Context Graph that are used by the simulation and artificial intelligence modules to provide input, output and bias to the HN system graph.

Embedding the HN Graph into the Context. Referring now to FIG. 11, the barycenter of the HN graph (1510) is positioned at the barycenter of the context space. An connection edge (1512a, b, c) is created between the input node (1506a), as projected on the surface of the context space boundary (1502), to the corresponding input node on the HN graph. Similarly, the output (1512b) and bias nodes are connected. The HN graph is oriented by quaternion such that the connecting edge lengths added above are minimized. The temperature of the context is assigned to the temperature of the vertices of the graph, such that the HN graph and its context are in thermal and dynamic equilibrium.

Manipulation of Graph Model Objects. The graph models, both in the form of the HN system graph and the Context Graph, may be manipulated in the following ways:

(1) When energy throughput and temperature differential affect a HN system graph and its context, the configuration of the graph is altered by the force directed graph and simulated annealing methods.

(2) When a change in measurement upon a context space (a change in meaning), the change in the context graph changes the energy minimization dynamics of the HN system graph and context. This also changes Item (1).

(3) When a new set of dimensions changes the shape of the context, the resulting fields change the forces acting upon the HN graph. This changes both Items (1) and (2).

Graphical Display of Complex Objects. The graphical display of the invention uses a 4 dimensional graphics pipeline technology such as DirectX or OpenGL in conjunction with compatible graphics hardware referred to as the GPU. The vertex data is indexed and stored separately from any metadata and metamodels in the GPU memory sections referred to as the vertex buffer, and the index buffer, respectively. A viewpoint consisting of an up reference vector from the context space, an aspect ratio of the height and width of the viewport, a viewing distance (all distances in float-pixel units) from the barycenter of the context to the viewport, a point being “looked at”, and a distance from the viewport to the back viewing plane create a viewing space referred to as a frustum. The display from this world view has no thermodynamic effect on either the model or context.

The three dimensional representation of context subspace may be wound or unwound from the spinor objects linking the dimensions. The display hints at the revolution of the spinoral path and dissolves the objects and spaces being exchanged with their non-linear complex conjugates. Objects and spaces thus coming into reality are “faded in”. The traditional “boxes in boxes” approach is not used, due to the non-linearity from spinoral dimensional rotation. The rate of navigation of the spinor path is controlled by trackball or mousewheel.

Temporal representations may be bifurcated between two views. These views consist of timelines that are shown by animation, either discrete or continuous, and unit cycles. Unit cycles may represent phase spaces or propagated along the timeline as frequency domains. Temporal spaces and configuration spaces may be shown in different windows contemporaneously, so thermal conformation changes may be show relative to the temporal domain views.

These are accomplished by quaternion manipulation of the matrix subsets within the graphics memory. The parameters of the frustum and the viewpoint impart a meaning context consistent human perspective by resolving projection non-linearities through reciprocal homogeneous W coordinates.

The actual representation on the computer monitor screen may be handled by placing the mathematically manipulated projection space into a back-buffer and swapping the back-buffer with the presentation buffer (front buffer) during retrace. In this implementation, the contents of the front buffer are discarded.

In one embodiment of the present invention, a storage medium is encoded with a machine readable computer program for creating, manipulating, traversing, visualizing and storing models as graph elements in a computer memory. That program or module may be for creating and manipulating data of graph structures, spaces and objects, referred to as GraphLib. The module may also provide a set of mathematical structures, properties and methods related to mathematical functions, referred to as MathLib. The module may also simulate the flow of energy by injection through the HN system graph from the Interfaces and by surjection upon the HN system graph from field effects and temperature, and visually represent the HN system on graphs and associated spaces.

A method of another embodiment of the invention is for creating an object in computer memory that represents a network graph, including: (a) A collection of vertex objects, and (b) A collection of edge objects, where an edge couples two vertices. The method may create a hybrid network graph object used to represent a hybridization of directed graphs, bond graphs and neural networks. It may also create an object that represents a Context in which such objects may be embedded, with the context having: (a) An object in computer memory representing a Context Space, (b) An object in computer memory representing an Environmental Space, (c) An object in computer memory representing a Context Graph, and (d) An object in computer memory representing an Interface, consisting of a set of graph node elements. The method may also extract data from a file, or data stream, and transforms it into a graph structure whose vertices represent structure and edges represent couplings. Data may be extracted from within a Document Object Model (DOM) object and transforms it into a graph structure whose vertices represent structure and edges represent couplings. The extraction of information may be from UML models, at present UML v2.1.18 as encoded in a DOM from an XML file such as XMI and transforms that information into a graph structure. The method may further extract information from SysML models encoded in a DOM, at present OMG SysML v1.0. The extraction of data may also be from an XML based text file and be transformed into a hierarchical graph structure of elements known as as the Document Object Model (DOM). The method may also extract information from DIMACS text files and transforms it into a graph structure, or from GraphML files. A further embodiment includes extracting information from the nouns, pronouns, adjectives, verbs and adverbs in natural textual language and maps said information to a Context Graph structure.

The method may also embed the context-free HN graph into a n-dimensional context space for the following: (a) to manipulate inputs and biases into the HN system graph for the purposes of simulation, (b) to measure the output of a HN system graph model, and (c) to represent external and environmental influences on a HN system graph. The method may use energy minimization gradient to align the graph and manipulating its orientation by a virtual quaternion. The dimensional degree of freedom may be extended to existing orthogonal dimensions by spinor progression.

Another aspect of the present invention involves a method for conversion of cycles, epicycles and phases in digraphs into frequencies upon a component of one or more temporal domains. The method contemplates representing the probabilistic selection of discrete, mutually exclusive (mutex) vertex junction sets and the probabilistic modulation of joint distribution vertex junction sets. Such a method may computationally simulate the behavior of a system as represented by the HN system graph, including a graph within a Context. The method may further simulate energy input, flow and output through context space to and from Interfaces, with extensions for modeling continuous energy IO through the graph under observation by way of the context (injection or surjection).

A further aspect of the present invention involves determining energy flow capacity of a product or process, represented as an edge in a HN bond graph, given a set parameters of energy differential, impedance, capacity, entropy and time. Such a method may be implemented by analogy of simulating linear, non-linear, and intermittent or turbulent flow of energy through the edges (arcs, traces) of a graph based upon potential, force or “temperature” difference induced in a vertex by stream or a pulse given an edge capacity, entropy, length and time. Total retained temperature/energy flow of the graph/context system may be determined for energy-entropy analysis.

A still further aspect of the present invention involves a method for using the derived graph structure as a navigable small world construct for ameliorating Kolmogorov/Chaitin informational complexities by seeking to minimize time and energy. Such a method may measure relative system complexity by measuring the energy inputs, energy outputs—including work and heat compared with network paths taken vs. shortest possible paths through the network, and the various capacities through those paths. Alternatively, HN sources and sinks may be extended to context interface nodes on the Context Graph as a means of modeling the interactions of complex systems.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A computer for assisting a user in solving a complex problem, said computer comprising:
a processor and memory for storing instructions;
a hybrid network software module in said memory, said hybrid network software module enabling a multi-dimensional mathematical model of a real world situation based on relevant parameters;
a context software module in said memory, said context software module providing the parameters to said hybrid network software and defining relationships with said hybrid network software module, said context software module further including an interface for allowing the user to change the parameters and the relationships; and
a manipulation software module in said memory, said manipulation software module adapted to change at least one of said hybrid network software module and said context software module based on one of changes to the internal definition of the mathematical model and changes in values external to the mathematical model.

2. The computer system of claim 1 further comprising a flow module adapted to calculate flow patterns within said hybrid network.

3.-15. (canceled)

16. The computer system of claim 2 wherein said flow module includes an energy minimization calculation module.

17. The computer system of claim 16 wherein said energy minimization calculation module includes at least one of a forward analysis and a reverse analysis.

18. The computer system of claim 17 wherein said energy minimization calculation module includes a Monte Carlo simulation module.

19. The computer system of claim 1 wherein said manipulation software module includes graphical display software.

20. The computer system of claim 1 wherein said hybrid network module includes vertex identification software.

21. The computer system of claim 1 wherein said hybrid network module includes edge identification software.

22. The computer system of claim 1 further comprising a node organization module for defining a plurality of nodes, and associating vertices of said hybrid network module with parameters of said context software module by said nodes.

23. The computer system of claim 22 wherein said manipulation software module has software adapted to modify a first one of said plurality of nodes based on a change in a second one of said plurality of nodes.

24. In computer, a method of assisting a user in solving a complex problem, said method comprising the steps of:
creating a multi-dimensional mathematical model of a real world situation based on relevant parameters using a hybrid network and a context module;
providing the parameters to the context module and defining relationships within the hybrid network software; and
manipulating of at least one of the hybrid network and the context module based on one of changes to the internal definition of the mathematical model and changes in values external to the mathematical model.

25. The method of claim 24 further comprising the step of calculating flow patterns within the hybrid network.

26. The method of claim 25 wherein said step of calculating flow patterns includes calculating energy minimization.

27. The method of claim 26 wherein said step of calculating energy minimization includes at least one of a forward analysis calculation and a reverse analysis calculation.

28. The method of claim 27 wherein said step of calculating energy minimization calculation module includes performing a Monte Carlo simulation.

29. The method of claim 24 wherein the step of manipulating includes providing a graphical display of the hybrid network.

30. The method of claim 24 further comprising the step of identifying a vertex in the hybrid network module.

31. The method of claim 24 further comprising the step of identifying an edge in the hybrid network module.

32. The method of claim 24 further comprising the steps of defining a plurality of nodes, and associating vertices of said hybrid network with parameters of said context software module by the nodes.

33. The method of claim 32 wherein said manipulating step includes modifying a first one of the nodes based on a change in a second one of the nodes.

34. A machine-readable program storage device for storing encoded instructions for a method of assisting a user in solving a complex problem, said method comprising the steps of:
creating a multi-dimensional mathematical model of a real world situation based on relevant parameters using a hybrid network and a context module;
providing the parameters to the context module and defining relationships within the hybrid network software; and
manipulating of at least one of the hybrid network and the context module based on one of changes to the internal definition of the mathematical model and changes in values external to the mathematical model.

35. The machine readable program storage device of claim 34 wherein said method further comprises the step of calculating flow patterns within the hybrid network.

36. The machine readable program storage device of claim 35 wherein said method has the step of calculating flow patterns including calculating energy minimization.

37. The machine readable program storage device of claim 36 wherein said method has the step of calculating energy minimization including at least one of a forward analysis calculation and a reverse analysis calculation.

38. The machine readable program storage device of claim 37 wherein said step of calculating energy minimization calculation module includes performing a Monte Carlo simulation.

39. The machine readable program storage device of claim 34 wherein said method has the step of manipulating including providing a graphical display of the hybrid network.

40. The machine readable program storage device of claim 34 wherein said method further comprises the step of identifying a vertex in the hybrid network module.

41. The machine readable program storage device of claim 34 wherein said method further comprises the step of identifying an edge in the hybrid network module.

42. The machine readable program storage device of claim 34 wherein said method further comprises the steps of defining a plurality of nodes, and associating vertices of said hybrid network with parameters of said context software module by the nodes.

43. The machine readable program storage device of claim 42 wherein said method has the manipulating step including modifying a first one of the nodes based on a change in a second one of the nodes.
